(19) United States
(12) Patent Application Publication
(10) Pub. No.: US 2025/0160345 A1
(43) Pub. Date: May 22, 2025

(54) MEAT INJECTION DEVICE

(71) Applicant: FOMACO A/S, Køge (DK)

(72) Inventors: Karsten Stitz Krog, Ringsted (DK); Naveed Yousaf, Taastrup (DK); Martin Fenger, Greve Landsby (DK)

(73) Assignee: FOMACO A/S, Køge (DK)

(21) Appl. No.: 18/864,036

(22) PCT Filed: May 10, 2023
(86) PCT No.: PCT/DK2023/050115

§ 371 Date: Nov. 8, 2024

(30) Foreign Application Priority Data
May 12, 2022 (DK) PA202270251
May 12, 2022 (DK) PA202270252
May 12, 2022 (DK) PA202270253
May 12, 2022 (DK) PA202270256

(51) Int. Cl. A22C 17/00; A22C 9/00

(52) U.S. Cl. CPC A22C 17/0053; A22C 9/001

(57) ABSTRACT

An injection device for injecting a liquid into meat includes a housing, a conveyor, and a modular needle bridge arranged above and across an endless belt conveying surface of the conveyor. A drive system is provided to move the conveying surface in at least two opposite conveying directions. The needle bridge has vertically stacked needle bridge blocks with aligning means, and needle head cavities of a non-circular cross-section for receiving correspondingly shaped needle heads with hollow injection needles that can move vertically in the needle head cavities. The needle head cavities are arranged in rows to form a continuous regular injection pattern.

### TECHNICAL FIELD

The disclosure relates to a device for injecting liquids into meat products, a needle bridge for the meat injection device, modular needle bridge blocks for assembling the needle bridge, needle heads for the needle bridge, a drive system for the meat injection device, a method of manufacturing the needle heads and the needle bridge blocks, and a method of injecting meat using the meat injection device.

### BACKGROUND

The process of tenderizing or basting meat has been performed for many years to improve the taste and/or tenderness of meat products prior to consumption. In classic examples, meats were basted by applying fluids to the surface, or a hand tool such as a mallet or hammer was used having series of teeth to strike a meat product to create openings. These openings were often also used to introduce an edible fluid, such as a brine, to permeate the meat. The brine typically served to further soften the meat and also to introduce flavorings.

Automated meat injection devices are nowadays well known in the meat industry. These devices usually have a fluid manifold with fluid reservoirs and group of injection needles associated with the reservoirs. The purpose of these machines is to inject brine into meat pieces at a pre-determined percentage rate at a larger scale, with the main purpose of improving conservation, adding flavor, and adding volume. It is further known to use needle bridges or injection heads in devices intended for injecting brine to meat pieces on a support surface of a meat conveyor. These needle bridges generally comprise a main body and a plurality of parallel hollow needles that can be retracted with respect to the main body against elastic means acting on an upper end of each needle opposite the tip thereof. In such injection devices, the bridge is actuated by driving means to vertically reciprocate between an upper position, in which the tip of the needles is at a distance from the support surface of the conveyor sufficient for enabling the meat pieces to pass under the needle bridges, and a lower position, in which the lower needle portions of the needles are stuck into the meat pieces located under the needle bridges. Brine supplying means are usually provided for supplying brine to an inlet opening of each needle when they are in the lower position.

It is also known to provide a meat injection device with two or more needle bridges installed at the same level over a conveyor for consecutively injecting brine to meat pieces on the conveyor, usually in order to increase the amount of total brine injected into each meat piece. Each of the needle bridges can include an array of parallel hollow injection needles mounted thereon substantially perpendicular to the support surface of the conveyor, each injection needle having a longitudinal inner passage for the brine to be injected.

A key aspect of introducing brine or solution in the meat in an effective manner is that the solution is distributed evenly. This avoids obtaining untreated areas and so-called “brine pockets”, wherein an amount of brine above the absorption capacity of the surrounding meat is injected. To this end, it is a long-sought goal to provide injecting apparatuses that enable regular and dense injection sites in the meat. The construction of both needles and needle bridges must be sturdy to meet the requirement of withstanding harsh and repetitive mechanical stresses during operation. This requirement sets a lower limit to the size of needle heads and needle cavities in the corresponding needle bridges for housing the needle heads and, thus, an upper limit to the number and density of needles carried by a needle bridge. An attempted prior art solution is increasing injection site density, as disclosed in WO2010061406A1, at least in the direction of travel of the conveyor belt, by decreasing the stroke travel distance so to increase the injection site frequency on the meat to brine. However, while being a suboptimal solution by only increasing injection site density along one dimension, this approach also results in an increased stroke to coverage ratio and increased wear on all component parts of the machine. Therefore, there exists a need to provide a solution that allows for a more regular and dense injection site pattern for meat injection while maintaining a comparatively low operation rate.

Among other shortcomings of existing meat injection devices are insufficient control over the amount of injected brine in the meat products; lack of adaptability of needle bridges to cover different meat sizes and to fit different conveyor dimensions; difficulty in cleaning the components, especially the needle bridges; loss of brine material; and difficulty in filtering brine material causing a blockage of needles.

### SUMMARY

It is therefore a principal object of the present disclosure to provide a meat product injection device that addresses and overcomes at least some of the above and other shortcomings of existing meat injection machines.

The foregoing and other objects are achieved by the features of the independent claims. Further implementation forms are apparent from the dependent claims, the description and the figures.

According to a first aspect, there is provided a modular needle bridge block for assembling a needle bridge of a meat injection device, the modular needle bridge block comprising aligning means for aligning a plurality of needle bridge blocks adjacently, the modular needle bridge block comprising at least one needle head cavity for receiving a needle head, the needle head cavities defining a non-circular cross-section at least along a portion of their length.

Such a modular needle block provides the advantages over the existing prior art that a plurality of needle bridge blocks can be arranged adjacently and/or stacked on top of each other, thereby allowing for great variability to fit different meat sizes and conveyor dimensions. Such modular blocks are easy to assemble and dismantle and allow for more efficient cleaning of the needle bridge components. Furthermore, the modular needle blocks are simpler and more cost effective to manufacture at scale than the complex and varying components of prior art needle bridges. The ability to align adjacent modular needle blocks and the needle head cavities defining a non-circular cross-section further allows for regular and specific needle patterns which can ensure uniform distribution of brine in the meat products to be injected.

In a possible implementation form of the first aspect, the at least one needle head cavity is arranged as a through-hole connecting two opposite surfaces of the needle bridge block, wherein the aligning means are configured to align a plurality of modular needle bridge blocks stacked on top of each other, the needle cavities thereby defining a continuous passage for a needle head to move within.

In a further possible implementation form of the first aspect, the modular needle bridge blocks comprise a plurality of needle cavities arranged spaced evenly at a third distance d3.

In a further possible implementation form of the first aspect, the plurality of needle cavities are arranged with respect to each other and the respective edges of the modular needle bridge block such that needle head cavities of one block and needle head cavities of adjacent blocks are spaced evenly at a third distance d3 when a plurality of modular needle bridge blocks are arranged adjacently.

In possible implementation form of the first aspect, the aligning means are arranged between at least one of the pair of rows of needle cavities.

In possible implementation form of the first aspect, the bridge block is further provided with temporary attachment means, for securing blocks together during assembly of the needle bridge, such as magnetic elements arranged on one or more sides of a modular needle bridge block.

In a further possible implementation form of the first aspect, the aligning means are inter-lockable.

In a further possible implementation form of the first aspect, the aligning means comprises at least one protrusion or depression arranged on a first surface of a block for receiving a corresponding protrusion arranged on a different modular needle bridge block for aligning a plurality of modular needle bridge blocks adjacently.

In a further possible implementation form of the first aspect, the aligning means comprises at least one protrusion or depression arranged on a first surface of a block and at least a protrusion or depression arranged on either the first surface or a second surface of the block different from the first surface for receiving a corresponding protrusion arranged on a different modular needle bridge block for aligning a plurality of modular needle bridge blocks adjacently.

In a further possible implementation form of the first aspect, the first surface and the second surface are arranged on opposite sides of the block for aligning a plurality of modular needle bridge blocks when stacked on top of or adjacently to each other.

In a possible implementation form of the first aspect at least two blocks further comprise fastening means for releasably fastening the at least two blocks to each other.

In a possible implementation form of the first aspect, the fastening means comprises means for securing the fastening of the at least two blocks to each other, such as a hook and pin, a screw, a bolt, or a quick-release mechanism.

In a further possible implementation form of the first aspect, the modular needle bridge block comprises at least one guide channel configured for receiving elongated fastening means, the guide channel being arranged to form a continuous channel through a plurality of needle bridge blocks when stacked on top of or adjacently to each other.

In a possible implementation form of the first aspect, the guide channels are integrated with the alignment means for saving space on the surfaces of the blocks, wherein each guide channel comprises a protrusion and a depression arranged on opposite surfaces of the needle bridge block.

In a possible implementation form of the first aspect, the needle bridge block further comprises additional through-holes running parallel to the guide channels, to accommodate for additional columns required for the operation of the needle bridge, such as a pair of pawl columns for supporting a stripping plate, and a pair of spring columns for supporting column springs arranged thereon for adjusting the tension on the stripping plate.

In a further possible implementation form of the first aspect, the periphery of at least one needle head cavity defines a non-circular cross-section at least along a portion of its length, the non-circular periphery lying substantially orthogonally to the longitudinal axis, the non-circular cross-section corresponding to the shape of a needle head base.

In a possible implementation of the first aspect, the periphery of the cross section of the needle cavity in the needle bridge block comprises at least two arcs that do not share the same center.

In a possible implementation form of the first aspect, the periphery of the cross section of the needle cavity in the needle bridge block comprises three first arcs substantially equal in curvature and length, and three second arcs substantially equal in curvature and length, the curvature and/or length of the second arcs being different from the first curvature and length of the first arcs, such that the periphery defines a shape with three-fold rotational symmetry.

In possible implementation form of the first aspect, the needle bridge blocks are manufactured as solid blocks, either by additive manufacturing such as milling, casting, molding, or 3D printing, or subtractive manufacturing; with the needle cavities and aligning means provided as cavities, protrusions, and recessions in the solid blocks.

In a further possible implementation form of the first aspect at least one of the first blocks and/or second blocks comprises a polymer, such as polyoxymethylene.

In a possible implementation form of the first aspect at least one of the first blocks and/or second blocks comprises a polymer selected from a group comprising polyethylene terephthalate (PET), PETP, ertalyte TX (PETP-TX), polyethylene (PE), polyether ether ketone (PEEK), polytetrafluoroethylene (PTFE), polyvinylidene fluoride (PVDF) and polypropylene (PP).

In a further possible implementation form of the first aspect at least one of the first blocks and/or second blocks comprises a metal selected from a group comprising EN1.4418; EN1.4405; EN1.4401; EN1.4301; EN1.4305; and EN1.4307.

According to a second aspect, there is provided a modular kit for assembling a needle bridge of a meat injection device, the modular kit comprising at least one first block according to any possible implementation form of the first aspect, a and a second block configured to be stacked adjacent to a first block, the second block comprising aligning means for aligning the second block with the at least one first block in a stacked arrangement, wherein at least one of the second blocks comprises liquid supply means arranged to be in fluid communication with the at least one needle head cavity of a corresponding first block when the second block is stacked on top of the first block.

In a possible implementation form of the second aspect the second block comprises a second block bottom surface for placing on top of a corresponding first block, and wherein the liquid supply means comprises at least one liquid channel arranged in the second block bottom surface, each liquid channel being arranged to align with at least one needle head cavity of the corresponding first block to define a sealed fluid communication passage between the at least one needle head cavity and the liquid channel.

In a possible implementation form of the second aspect, the seal is provided by sealing means, such as an O-ring or a flat gasket comprised between the second block bottom surface and the corresponding first block.

In a possible implementation form of the second aspect, the seal is provided by fine tolerance compression between the two blocks.

In a possible implementation form of the second aspect, the seal is provided by two conical surfaces arranged on the surfaces of the first and second blocks.

In a possible implementation form of the second aspect, the liquid supply means comprises at least one liquid channel arranged in the second block bottom surface, each liquid channel being arranged to align with one needle head cavity of the corresponding first block. Such an arrangement may advantageously reduce the brine overflow between channels.

In a further possible implementation form of the second aspect each liquid channel is arranged as an elongated recess in the second block bottom surface, and wherein the at least one first block comprises a plurality of needle cavities arranged in at least one row, each row of needle cavities being aligned with a liquid channel of a corresponding second block to define a sealed fluid communication passage between the row of needle cavities and the liquid channel. Such an arrangement may provide simplicity for replacing parts such as sealing means of increased ease of manufacturing.

In a further possible implementation form of the second aspect, the second block comprises a plurality of elongated liquid channels arranged parallel to each other.

In a further possible implementation form of the second aspect, the liquid supply means further comprises a liquid inlet arranged in the second block configured to be connected to a liquid source, and at least one liquid valve arranged between the liquid inlet and the at least one liquid channel.

In a further possible implementation form of the second aspect, the second block comprises a corresponding liquid valve arranged between the liquid inlet and each of the at least one liquid channels for independent supply of liquid to each of the liquid channels.

In a further possible implementation form of the second aspect, the second block comprises a pressure relief valve.

In a further possible implementation form of the second aspect, the liquid valve and/or the pressure relief valve are operatively connected through rocker arms to pawl columns arranged in the needle bridge when assembled.

In a further possible implementation form of the second aspect at least one of the first blocks and/or second blocks comprises a polymer, such as polyoxymethylene.

In a possible implementation form of the second aspect at least one of the first blocks and/or second blocks comprises a polymer selected from a group comprising polyethylene terephthalate (PET), PETP, ertalyte TX (PETP-TX), polyethylene (PE), polyether ether ketone (PEEK), polytetrafluoroethylene (PTFE), polyvinylidene fluoride (PVDF) and polypropylene (PP).

In a further possible implementation form of the second aspect at least one of the first blocks and/or second blocks comprises a metal selected from a group comprising EN1.4418; EN1.4405; EN1.4401; EN1.4301; EN1.4305; and EN1.4307.

According to a third aspect, there is provided a needle bridge for a meat injection device, the needle bridge comprising a plurality of modular needle bridge blocks arranged adjacently and aligned by aligning means to define a needle bridge bottom surface, each modular needle bridge block comprising at least one needle head cavity for receiving a needle head, with each of the needle head cavities being accessible from the needle bridge bottom surface.

In a possible implementation form of the third aspect, the needle bridge comprises a plurality of modular needle bridge blocks according to any possible implementation form of the first aspect arranged adjacently and aligned by the aligning means comprised in the modular needle bridge blocks to define a needle bridge bottom surface, with each of the needle head cavities being accessible from the needle bridge bottom surface.

In a possible implementation form of the third aspect at least two of the modular needle bridge blocks are arranged to be stacked vertically on top of each other and are vertically dimensioned to cover the full height requirement of the needle bridge for use in a brine injecting machine.

In another possible implementation form of the third aspect, the aligning means comprises a frame configured for receiving a plurality of modular needle bridge blocks arranged adjacently along at least one axis.

In an embodiment, the frame is configured for receiving a plurality of modular needle bridge blocks arranged adjacently along at least two substantially perpendicular axes. In another embodiment, the frame is configured for receiving a plurality of modular needle bridge blocks arranged adjacently along three substantially perpendicular axes in three dimensions.

According to a fourth aspect, there is provided a needle bridge for a meat injection device, the needle bridge assembled from a modular kit according to any possible implementation form of the second aspect, comprising a second block stacked on top of at least one first block and aligned by the aligning means to define a needle bridge bottom surface, with each of the at least one needle head cavity being accessible from the needle bridge bottom surface.

In a possible implementation form of the fourth aspect, the second block stacked on top of at least one first block defines a modular stack, wherein the needle bridge comprises a plurality of modular stacks arranged adjacently with respect to each other.

In a possible implementation form of the fourth aspect, the needle bridge comprises at least one modular stack array comprising a plurality of modular stacks arranged along a first axis, each modular stack array dimensioned to fulfill the width requirement of the needle bridge for use in a brine injecting machine.

In a further possible implementation form of the fourth aspect, the needle bridge comprises a plurality modular stack arrays arranged along a second axis substantially perpendicular to the first axis, the plurality modular stack arrays dimensioned to fulfill the length requirement of the needle bridge for use in a brine injecting machine.

In a possible implementation form of any of the above aspects, the plurality of modular needle bridge blocks or the second blocks and the first blocks are dimensioned substantially equally.

According to a fifth aspect, there is provided a meat injection device comprising conveyor means defining a conveying direction, the conveyor means comprising a conveying surface for placing meat products; the meat injection device further comprising a needle bridge according to any possible implementation form of the third aspect comprising a plurality of modular needle bridge blocks arranged adjacently and aligned by aligning means, each modular needle bridge block comprising at least one needle head cavity with a needle head arranged therein movably in a direction orthogonal to the conveying surface; wherein the plurality of modular needle bridge blocks are arranged to define successive rows of needle cavities in the conveying direction; wherein the conveyor means are configured to advance in a stepped manner in the conveying direction, each step advancing one step length S; and wherein a second distance d2 between successive rows of needle cavities in the conveying direction is equal to the step length d2=S.

In a possible implementation form of the fifth aspect, each of the needle heads comprise at least one needle, the needle cavities being arranged so that the needles are evenly distributed in the rows of needle cavities in an equilateral triangular pattern with a first distance d1 between the needles; and wherein the step length S is substantially an integer multiple of the first distance d1. As used herein, an integer multiple means any rational number that can be expressed as the sum or difference of a finite number of units, being a member of the set . . . 3, −2, −1, 1, 2, 3 . . . (not 0).

The equilateral triangular pattern of needles and the relationship between the step length of the conveyor means and the distance between the successive rows of needle cavities allows for a uniform pattern of liquid injection over varying dimensions of meat products, which in turn ensures that the liquid brine in the meat products conveyed below the needle bridge is evenly distributed.

In an embodiment the first distance d1=11 mm, and the step length S=33 mm.

According to a sixth aspect, there is provided a method for injecting meat comprising:
providing conveyor means defining a conveying direction, the conveyor means comprising a conveying surface;
providing a needle bridge according to any possible implementation form of the third aspect above the conveying surface by arranging a plurality of modular needle bridge blocks adjacently and aligning the plurality of modular needle bridge blocks by aligning means, each modular needle bridge block comprising at least one needle head cavity with a needle head arranged therein movably in a direction orthogonal to the conveying surface, so that the plurality of modular needle bridge blocks define successive rows of needle cavities in the conveying direction with a second distance d2 between successive rows;
placing meat products on the conveying surface; and
advancing the conveyor means in a stepped manner in the conveying direction, each step advancing one step length S, wherein the step length S is equal to the second distance d2 between successive rows of needle cavities, and
once the front portion of the meat product in the conveying direction is aligned with a first row of needle cavities, alternately injecting liquid into the meat product from needle heads arranged in successive rows of needle cavities and skipping injection for one step following each injection step, until the entire volume of the meat product is fully and evenly injected.

According to a seventh aspect, a needle head for use in a brine injecting machine, specifically a brine injection needle bridge, is provided, the needle head defining a longitudinal axis and comprising a base, wherein the base has a substantially non-circular cross section, the cross section lying substantially orthogonally to the axis, and at least one needle extending from the base.

By the needle head comprising a non-circular cross-section, a contiguous arrangement of a plurality of needle heads in a needle bridge that permits a denser needle distribution may be enabled.

In a possible implementation form of the seventh aspect, the needle head comprises a single needle extending from the base.

In a possible implementation form of the seventh aspect, the needle head comprises a plurality of needles extending from the base. The number of needles extending from the needle head base may be any number, such as two, three, four, five, six, seven, eight, nine, ten, eleven, twelve, etc.

By the needle head comprising a non-circular cross-section and further comprising a plurality of needles, such as two needles, the needle head may be arranged in a corresponding needle bridge in a manner that allows for a denser injection site pattern on the meat to be treated.

Dense needle pattern with high number of injection points promotes improved brine distribution.

In a certain implementation form of the seventh aspect, the needle head comprises at least three needles wherein the insertion points of three needles into the needle head base are arranged at substantially 60°.

By the angle between three needle insertion points into the needle head being substantially 60° all needles comprised in one needle head may be advantageously arranged equidistantly from two other needles.

In a possible implementation form of the seventh aspect, the conveyor belt travel distance per stroke corresponds to an integer multiple of the distance between two needle insertion points into the needle head. As used herein, an integer multiple means any rational number that can be expressed as the sum or difference of a finite number of units, being a member of the set . . . 3, −2, −1, 1, 2, 3 . . . (not 0). Thereby, a regular injection pattern is advantageously achieved on the meat when treated.

In a certain implementation form of the seventh aspect, the needle head comprises three needles wherein the insertion points of the needles into the needle head base are arranged equidistantly from each other. This number of needles per needle head offers an ideal balance between obtaining the desired effect of allowing a denser needle arrangement on the needle bridge while providing a needle head that is a unit of a size that is efficient to exchange from the needle bridge in case of needle breakage or uneven wear across the width of the conveyor belt.

In a certain implementation form of the seventh aspect, the needle head comprises a needle head plate for providing additional support and engagement surface for the needles to be arranged and fixed in the base. The needle head plate may be made of a material different from the base, and which can provide sufficient structural support for the needle ends, such as a metal. In an embodiment the needle head plate is a steel plate connected to the body via a screw.

In a possible implementation form of the seventh aspect, the periphery of the needle head cross section comprises at least two arcs that do not share the same center.

In a possible implementation form of the seventh aspect, the periphery of the needle head cross section defines a substantially regular curved polygon with constant width and is a Reuleaux triangle. In such a case, three needle insertion points are arranged in proximity to the vertices of the Reuleaux triangle. This arrangement advantageously allows for a plurality of such needle heads to be arranged closer to each other in a needle bridge, while allowing for sufficient distance between needle head cavities on the surface of a needle bridge to withstand the mechanical stresses generated during operation. The arrangement allows for closer arrangement of needles in a needle bridge than if they were comprised in a needle head with a periphery approximating a circle. Thus, this arrangement allows for a denser injection pattern.

In a certain implementation form of the seventh aspect, the periphery of the needle head cross section further comprises at least two straight sections. Thereby, the needle head cross section may define an oblong shape comprising straight sections connecting rounded ends, or, e.g., a triangle comprising straight sections connecting rounded corners.

By the arcs being arranged at the tips of an oblong shape or replacing the corners of, e.g., a triangle, the needle head base comprises a surface around its periphery that may make better contact with sealing means, thereby offering decreased leakage of brine around the needle head, which may reduce dripping.

In a possible implementation form of the seventh aspect, the periphery of the needle head cross section comprises a first arc and a second arc, the arcs each defined at least by a curvature and a length, wherein the first and second arcs differ in arc curvature. Thereby, connecting sections may also be rounded, albeit with less curvature when compared to the sections in the expected locations of the corners of a shape, and so also provide a needle head with a peripheral surface that offers decreased leakage of brine around the needle head, which may reduce dripping and waste of brine during operation.

In a possible implementation form of the seventh aspect, the first and second arcs differ in length.

In a possible implementation form of the seventh aspect, the periphery of the cross section comprises a first arc and a second arc, the arcs each defined at least by a curvature and a length, wherein the first and second arcs differ in arc curvature and, optionally, length, and, further, comprises at least one straight section.

In a possible implementation form of the seventh aspect, the cross-section periphery comprises at least two first arcs substantially equal in curvature and length, and at least two second arcs substantially equal in curvature and length.

Such an arrangement may enable the needle head cross section to define an oval shape that provides a surface around its periphery that may make improved contact with sealing means, thereby offering decreased leakage of brine around the needle head, which may reduce dripping and waste of brine during operation.

In a possible implementation form of the seventh aspect, the cross-section periphery comprises three first arcs substantially equal in curvature and length, and three second arcs substantially equal in curvature and length such that the periphery defines a shape with three-fold rotational symmetry. While incorporating the advantages of the implementation forms described herein above, this arrangement offers the possibility of including three needles per needle head, which is an ideal number of needles per needle head. In this arrangement, three needle insertion points are arranged in proximity to arcs of greater curvature, i.e., narrower turn. This arrangement advantageously allows for a plurality of such needle heads to be arranged closer to each other in a needle bridge, while allowing for sufficient distance between needle head cavities on the surface of a needle bridge to withstand the mechanical stresses generated during operation. The arrangement allows for closer arrangement of needles in a needle bridge than if they were comprised in a needle head with a periphery approximating a circle. Thus, this arrangement allows for a denser injection pattern.

In a possible implementation form of the seventh aspect, the needle head base comprises a groove arranged peripherally for releasably attaching sealing means. Sealing means may be an O-ring, a gasket, or similar means. By the means being releasably attachable, it is possible to conveniently replace the sealing means when an existing one has reached the end of its useful life.

In a possible implementation form of the seventh aspect, the depth or the width of the peripherally arranged groove varies more than 5%, such as between 10% and 20%, along the periphery of the needle head base.

In a certain implementation form of the seventh aspect, the depth or the width of the peripherally arranged groove is more than 5%, such as between 10% and 20% smaller along sections of the periphery of the needle head base that coincide with short arcs with tighter curvature as described herein above.

With the depth or the width of the peripherally arranged groove being smaller along sections of the periphery of the needle head base that coincide with the short arcs with tighter curvature, the sealing means, such as an O-ring, protrudes further outward along the periphery of the needle head base where the curvature is tighter, thereby compensating for increased stretch on the sealing means at these locations due to the tighter curvature. The effect is that the seal is tighter in these areas, and the needle head offers improved water tightness all around.

In an alternative implementation form of the seventh aspect, the needle head base comprises integrated sealing means, such as a radial protrusion arranged peripherally around the circumference of the needle head base. By the sealing means being integrated with the needle head base, such as by an injection moulding process, it is possible to eliminate the need for an additional sealing means, such as an O-ring or a gasket.

In a possible implementation form of the seventh aspect, the needle head comprises one or more polymers.

In a possible implementation form of the seventh aspect, the needle head comprises polyoxymethylene (POM).

In a possible implementation form of the seventh aspect, one or more polymers comprised in the needle head are selected from a group comprising Polyethylene terephthalate (PET), PETP, Ertalyte TX (PETP-TX), Polyethylene (PE), Polyether ether ketone (PEEK), Polytetrafluoroethylene (PTFE), Polyvinylidene fluoride (PVDF) and Polypropylene (PP).

In a further possible implementation form of the seventh aspect, the needle head comprises an EN1.4 metal, such as metal selected from a group comprising EN1.4418; EN1.4405; EN1.4401; EN1.4301; EN1.4305; and EN1.4307.

According to an eighth aspect, there is provided a needle bridge block comprising at least one needle cavity defining a longitudinal axis, wherein the cavity defines a substantially non-circular periphery at least along a section of the longitudinal axis, the non-circular periphery lying substantially orthogonally to the longitudinal axis.

In a possible implementation of the eighth aspect, the periphery of the cross section of the needle cavity in the needle bridge block comprises at least two arcs that do not share the same center.

In a possible implementation of the eighth aspect, the periphery of the cross section of the needle cavity in the needle bridge block defines a substantially regular curved polygon with constant width and is a Reuleaux triangle.

In a possible implementation of the eighth aspect, the periphery of the cross section of the needle cavity in the needle bridge block further comprises at least two straight sections.

In a possible implementation of the eighth aspect the periphery of the cross section of the needle cavity in the needle bridge block comprises at least a first arc and a second arc, the arcs each defined at least by a curvature and a length, wherein the first and second arcs differ in arc curvature and optionally, also differ in length.

In a possible implementation of the eighth aspect the periphery of the cross section of the needle cavity in the needle bridge block comprises a first arc and a second arc, the arcs each defined at least by a curvature and a length, wherein the first and second arcs differ in arc curvature and, optionally, length, and, further, comprises at least one straight section.

In a possible implementation of the eighth aspect, the periphery of the cross section of the needle cavity in the needle bridge block comprises at least two first arcs substantially equal in curvature and length, and at least two second arcs substantially equal in curvature and length, the curvature and/or length being different from the first curvature and length.

In a possible implementation of the eighth aspect, the periphery of the cross section of the needle cavity in the needle bridge block comprises three first arcs substantially equal in curvature and length, and three second arcs substantially equal in curvature and length, the curvature and/or length of the second arcs being different from the first curvature and length of the first arcs, such that the periphery defines a shape with three-fold rotational symmetry.

In a possible implementation of the eighth aspect, the needle bridge comprises a plurality of modular needle bridge blocks arranged adjacently and aligned by aligning means to define a needle bridge bottom surface, each modular needle bridge block comprising at least one needle head cavity for receiving a needle head according to any implementation form of the seventh aspect, with each of the needle head cavities being accessible from the needle bridge bottom surface.

In a possible implementation form of the eighth aspect, the needle bridge block comprises a plurality of needle cavities, wherein the cavities' centers and the cavities' orientation are arranged such that a distance between the plurality of the needles' insertion points in one needle head base is substantially equal to a distance between two needles' insertion points, the needles pertaining to two separate needle heads, when mounted in the needle bridge block.

In a possible implementation form of the eighth aspect, the needle bridge block comprises a plurality of needle cavities, wherein the cavities' peripheries centers and the cavities' peripheries orientation are arranged such that an angle between three needle insertion points in two needle head bases is substantially 60°, wherein at least 2 of the three needles are mounted on separate needle heads.

In a certain implementation form of the eighth aspect, the plurality of needle head cavities are arranged forming at least one row of aligned cavities, wherein the needle head cavities' angle of rotation of the periphery of the cross-section is substantially the same in relation to a longitudinal axis of the needle bridge block. In combination with the conserved distance between needle insertion points on one needle head and between the insertion points of 2 needles pertaining to different needle heads, this arrangement ensures that the resulting injection pattern on treated meat is one of great uniformity.

In a certain implementation form of the eighth aspect, the plurality of needle head cavities are arranged forming two rows of cavities and the cavities' angle of rotation differs 60° between rows. This arrangement advantageously allows for rows of needles striking at different locations in the meat being treated to perpetuate the regular pattern for obtaining a uniform injection pattern.

According to a ninth aspect, there is provided a method for producing a needle head as described herein, wherein the needle head base is milled, and the needle is assembled in the needle head with a heat-shrink fit.

In a possible implementation form of the ninth aspect, the needle is glass blasted such that the grip between needle and needle head is improved.

According to a tenth aspect, there is provided a method for producing a needle head, wherein the needle head is formed by injection molding.

By the method of producing a needle head and/or a needle bridge block comprising injection molding, production steps carried out in the prior art, such as drilling holes in the needle head base and/or needle bridge may be avoided. Thus, injection molding a polymer to form a needle head base and/or needle bridge block may greatly reduce production time and capital expenditure. Further, injection molding a polymer to form a needle head base and/or a needle bridge block may greatly improve tolerances when the molded needle head is mounted in a needle bridge cavity. This is because injection molding is a process wherein the final dimensions of the resulting product are more easily controlled. Indeed, milling entire parts or cavities with relatively large dimensions may cause generate embedded tensions and/or on the polymer material, which may lead to undesired material warping. Thus, injection molding offers less product variation and better tolerances between the mounted needle head in a needle bridge. Further, by mounting a needle head in a needle bridge of same material allows similar thermal expansion and compression of the two parts, since these will intrinsically be subject to the same heat expansion coefficient, thereby leading to better tolerance between the two parts across varying temperatures.

In a possible implementation form of the tenth aspect, injection molding is followed by machining. As used herein, machining is the process of cutting, shaping, or removing material from a workpiece using a machine tool. One such process is milling. Milling may be used for obtaining an improved finish of the final product.

In a particular implementation form of the tenth aspect, the needle head base comprises a polymer as disclosed herein and is injection molded onto at least one needle.

By the method of producing a needle head comprising injection molding, production steps carried out in the prior art, such as inserting the needle into a newly drilled hole, welding the needle onto the base, front soldering the needle to the head, and repeating for as many needle heads are to be produced may be avoided. Thus, injection molding a polymer directly onto a needle may greatly reduce production time and capital expenditure.

According to an eleventh aspect, there is provided a method for producing a needle head and/or a needle bridge block, wherein the needle head and/or a needle bridge block is formed by 3D-printing.

In a possible implementation form of the eleventh aspect, 3D-printing is followed by milling. The combination of 3D-printing followed by milling may be particularly advantageous since 3D-printing is cheap and fast, and subsequent milling ensures that the needle bridge cavities and the needle head bases may interact with improved tolerance. Thus, this production method ensures low production costs and high-quality products.

According to a twelfth aspect, a stripping plate suitable for use in a brine injecting machine is provided, wherein the stripping plate comprises a plurality of through-holes arranged in a pattern corresponding to a pattern defined by a plurality of needles according to a needle head according to any implementation form of the seventh aspect, as described herein above.

In possible implementation forms of the twelfth aspect, the stripping plate comprises m x n through holes depending on the number of needles in a single needle head, wherein m equals the number of needles in a single needle head, and n equals the number of needle heads according to the invention mounted in a needle bridge or wherein n equals the number of needle head cavities comprised in the needle bridge block according to any implementation form of the eighth aspect.

In a possible implementation form of the twelfth aspect, the stripping plate is spring-loaded using spring columns arranged in the needle bridge, wherein the spring columns have column springs arranged therein and multiple possible position settings for adjusting the spring tension on the stripping plate and thereby adjusting pressure of the stripping plate on the meat product to be injected.

According to a thirteenth aspect, there is provided an injection device for injecting a liquid into meat comprising:
a housing comprising at least two oppositely arranged lateral side walls, a bottom, and a top surface together defining an enclosure;
the top surface comprising two support walls separated by an upwardly opening channel extending substantially straight between and opening to the oppositely arranged side walls;
a conveyor comprising a conveying surface arranged in the channel for moving foodstuff along the channel in a conveying direction;
a needle bridge arranged above the conveying surface, the needle bridge comprising a plurality of hollow injection needles arranged movably in a direction orthogonal to the conveying surface; and an at least partially removable cover arranged above the channel, at least partially covering the needle bridge.

A meat injection device according to the thirteenth aspect allows for a reduced footprint both when in use and when not in use, while the removable cover enables easy access for removing and/or cleaning the components otherwise enclosed or covered, such as the conveyor and the needle bridge.

In an embodiment the channel is defined by a rectangular U-shaped cross-section at least along a portion of its length. In an embodiment the channel is defined by a rectangular U-shaped cross-section along its entire length.

In an embodiment the channel extends horizontally, wherein the conveying surface is also arranged horizontally with the plurality of hollow injection needles arranged to be vertically movable in the needle bridge.

In an embodiment the housing is defined by a rectangular cuboid shape with four lateral side walls.

In an embodiment the cover is arranged to correspond to the outline of the top surface and to fully cover the channel.

In an embodiment the cover is arranged to fully surround the needle bridge.

In an embodiment the cover is arranged on top of and supported by the support walls.

In a possible implementation form of the thirteenth aspect the at least partially removable cover comprises a cover frame extending over the needle bridge, and at least a first cover element and a second cover element disposed on opposite sides of the cover frame and arranged to be independently removable from above the channel.

In an embodiment the cover frame comprises two legs, each leg supported by one of the support walls.

In a further possible implementation form of the thirteenth aspect at least one of the first cover element and the second cover element are connected to the cover frame by at least one hinge element allowing the first cover element and/or the second cover element to be swung to an open position around the at least one hinge element to allow access to the needle bridge and/or the conveyor.

In an embodiment wherein at least one of the first cover element and the second cover element are at least partially transparent for allowing an operator to see through the cover even in a closed state. In an embodiment at least one of the first cover element and the second cover element comprises thermo molded, transparent polycarbonate shells.

In a further possible implementation form of the thirteenth aspect the conveying surface comprises an extended portion that extends from the channel in at least one direction beyond a respective side wall of the housing; wherein the conveyor comprises at least one foldable end section protruding from the side wall to support the extended portion of the conveying surface; and wherein the foldable end section is connected to the side wall through connection means allowing the foldable end section to be folded up or down for reducing the footprint of the device.

In a further possible implementation form of the thirteenth aspect the housing comprises a removable tank for supplying brine to the needle bridge, the removable tank being arranged to fit into the enclosure with its entire volume.

In a further possible implementation form of the thirteenth aspect the device further comprises a pump for pumping brine from the tank to the needle bridge, the pump being at least partially arranged within the enclosure.

In an embodiment the pump at least partially protrudes from the enclosure for allowing easier access for maintenance.

In a further possible implementation form of the thirteenth aspect the device further comprises at least one particle filter arranged downstream from the pump substantially within the enclosure. This allows preventing blockage of the injection needles.

In an embodiment the filter at least partially protrudes from the enclosure through an opening allowing easier access for maintenance.

In an embodiment the filter is a fine filter arranged for filtering out particles larger than 0.5 mm in diameter to prevent blockage of injection needles 12.

In an embodiment the device further comprises a coarse filter integrated in the tank for additional filtering upstream from the pump, arranged for filtering out particles larger than 2 mm in diameter.

In a further possible implementation form of the thirteenth aspect the device further comprises a control panel movably and/or removably connected to a side wall of the device housing, the control panel comprising a control interface allowing manual control of the device.

In an embodiment the control panel is substantially wing-shaped, with a substantially rectangular middle portion comprising the control interface, and two triangular side portions arranged on opposite sides of the middle portion.

In an embodiment the control interface comprises display means, such as a touchscreen module, and/or a rotatable knob for manually and dynamically adjusting various settings during operation.

In an embodiment the control panel is arranged to be removable using bolts, allowing efficient hardware and software updates without the need for changing or transporting the rest of the device.

In a further possible implementation form of the thirteenth aspect the housing further comprises liquid collecting means arranged within the enclosure below the conveyor for collecting brine overflowing the conveying surface, the liquid collecting means comprising at least one downward sloping guide surface for guiding the overflow brine to a trough, the trough comprising at least one opening arranged to let the collected brine to flow into the tank. This allows saving and reusing overflow brine that would otherwise be lost.

In a further possible implementation form of the thirteenth aspect the needle bridge comprises a plurality of stacked modular needle bridge blocks, the modular needle bridge blocks comprising a plurality of needle head cavities with a needle head arranged therein movably in a direction orthogonal to the conveying surface, each needle head comprising at least one injection needle.

This modular design allows for great variability to fit different meat sizes and conveyor dimensions. Such modular blocks are also easy to assemble and dismantle and enables more efficient cleaning of the needle bridge components. Furthermore, the modular needle blocks are simpler and more cost-effective to manufacture at scale than the complex and varying components of prior art needle bridges. The ability to align adjacent modular needle blocks further allows for regular and specific needle patterns which can ensure uniform distribution of brine in the meat products to be injected.

In possible implementation form of the thirteenth aspect, the needle bridge blocks are manufactured as solid blocks, either by additive manufacturing such as milling, casting, molding, or 3D printing, or subtractive manufacturing; with the needle cavities aligning means provided as cavities, protrusions, and and recessions in the solid blocks.

In an embodiment the edges and/or corners of the housing are chamfered for reducing any risk of accidents and for providing a distinct appearance.

According to a fourteenth aspect, there is provided an injection device for injecting a liquid into meat comprising a housing, a conveyor comprising a conveying surface arranged for moving foodstuff between an entrance arranged at one side of the housing and an exit arranged at an opposite side of the housing; a needle bridge arranged above the conveying surface, the needle bridge comprising a plurality of hollow injection needles arranged movably in a direction orthogonal to the conveying surface; and a drive system configured to move the conveying surface in at least two opposite conveying directions between the entrance and the exit.

A meat injection device according to the fourteenth aspect allows for an improved adaptability to different use cases and production layouts compared to prior art devices.

In an embodiment the drive system is configured to move the conveying surface in a direction from the entrance to the exit and also in a direction from the exit to the entrance.

In a possible implementation form of the fourteenth aspect the conveying surface is part of an endless belt arranged to be moved by at least one reversibly rotatable conveyor pulley operatively connected to the drive system.

In a further possible implementation form of the fourteenth aspect the conveying surface is arranged to revolve around at least one conveyor pin, the at least one conveyor pin being arranged removably in the conveyor to provide tension along the opposite conveying directions and to remove the tension when the at least one conveyor pin is removed from the conveyor.

In a further possible implementation form of the fourteenth aspect at least one conveyor pin is arranged to be accessible and removable from at least one side of the conveyor, allowing the conveying surface to be removed from the conveyor.

In a further possible implementation form of the fourteenth aspect the conveyor comprises at least one foldable end section arranged to be folded away into the housing once the conveyor pin is removed and tension on conveying surface is removed.

In a further possible implementation form of the fourteenth aspect the drive system is configured to move the conveying surface in a stepped manner in at least one of the conveying directions, each step advancing the conveying surface with one step length S per stroke of the needle bridge.

In an embodiment the needle bridge comprises successive rows of needles along the conveying directions with a second distance d2 defined between the successive rows; and wherein the second distance d2 between successive rows of needle cavities in the conveying direction is equal to the step length d2=S.

In an embodiment the step length is S=33 mm.

In a further possible implementation form of the fourteenth aspect the drive system comprises a Geneva drive comprising a drive gear driven by a reversible operation, continuously rotating drive means, the drive gear comprising a drive pin arranged to periodically engage and disengage a slot arranged in a Geneva gear, while turning the Geneva gear at an angle defined by the radius and the number of slots of the Geneva gear, thus converting the continuous rotation of the drive means into a stepped rotation of the Geneva gear.

In a further possible implementation form of the fourteenth aspect the conveying surface is arranged to be moved by at least one rotating conveyor pulley, and wherein the Geneva gear is operatively connected to the conveyor pulley through at least one timing belt.

In a further possible implementation form of the fourteenth aspect an angular gear is further arranged between the Geneva gear and the conveyor pulley.

In an embodiment the angular gear is arranged with a 1:1 ratio.

In a further possible implementation form of the fourteenth aspect the device further comprises a control interface allowing manual control of the conveying direction of the conveyor.

These and other aspects will be apparent from the embodiment(s) described below.

### BRIEF DESCRIPTION OF THE DRAWINGS

In the following detailed portion of the present disclosure, the aspects, embodiments and implementations will be explained in more detail with reference to the example embodiments shown in the drawings, in which:

FIG. 1 is an elevated view of the needle head according to the disclosure.

FIG. 2 is a detailed view of the needle head base according to the disclosure.

FIG. 3 is a lateral view of the needle head base.

FIG. 4 is an underneath view of the needle head base and needle insertion points.

FIG. 5 illustrates a sealing means according to the disclosure.

FIG. 6 is a top view of a non-circular needle base according to the disclosure.

FIG. 7 is an elevated view of an alternative needle head according to the disclosure.

FIG. 8 is a top view of an alternative, non-circular needle base according to the disclosure.

FIG. 9 is a bottom isometric view of a needle bridge block according to the disclosure.

FIG. 10 is a top isometric view of a needle bridge block according to the disclosure.

FIG. 11 illustrates possible needle head base periphery shapes according to the disclosure.

FIG. 12 illustrates possible needle head arrangements in a needle bridge block according to the disclosure.

FIG. 13 illustrates a possible injection pattern obtained on processed meat after injection with a needle bridge according to the disclosure.

FIG. 14 illustrates an example of an injection pattern resulting from use of a needle bridge and needle heads in accordance with an example of the disclosure.

FIG. 15 is an elevated view of two assembled needle bridge blocks according to the disclosure.

FIG. 16 is an underside view of two assembled needle bridge blocks according to the disclosure.

FIG. 17 is an underside view of a second needle bridge block according to the disclosure.

FIGS. 18 and 19 are an elevated and underside views of an assembled stack of needle bridge blocks according to the disclosure.

FIG. 20 is front view of a needle bridge in a brine injecting machine according to the disclosure.

FIGS. 21 and 22 are elevated and lower views of a needle bridge according to the disclosure.

FIG. 23 is a representation of an injection sequence according to the disclosure.

FIG. 24 is a representation of a modular stack array comprising a plurality of modular stacks arranged along a first, second and third axes according to the disclosure.

FIG. 25 shows a meat injection device according to the disclosure.

FIG. 26 is a left side view of a meat injection device according to the disclosure.

FIG. 27 is a front view of a meat injection device according to the disclosure.

FIG. 28 is a top view of a meat injection device according to the disclosure.

FIGS. 29 and 30 are elevated views showing the right side of a meat injection device according to the disclosure with both cover elements on and one of the cover elements removed.

FIGS. 31 and 32 are elevated views showing the left side of a meat injection device according to the disclosure with both cover elements on and one of the cover elements removed.

FIGS. 33 and 34 are cross-sectional side and front views of a meat injection device according to the disclosure.

FIG. 35 is a cut-away isolated view of the conveyor of a meat injection device according to the disclosure.

FIG. 36 is a detailed front view of a modular needle bridge for a meat injection device according to the disclosure.

FIGS. 37 and 38 are cut-away detailed views of the valves of a modular needle bridge according to the disclosure.

FIGS. 39-41 are cut-away views of a drive system for a meat injection device according to the disclosure.

FIGS. 42-44 are elevated views of different cover element arrangements for a meat injection device according to the disclosure.

FIG. 45 is an isometric view of a cover element for a meat injection device according to the disclosure.

### DETAILED DESCRIPTION

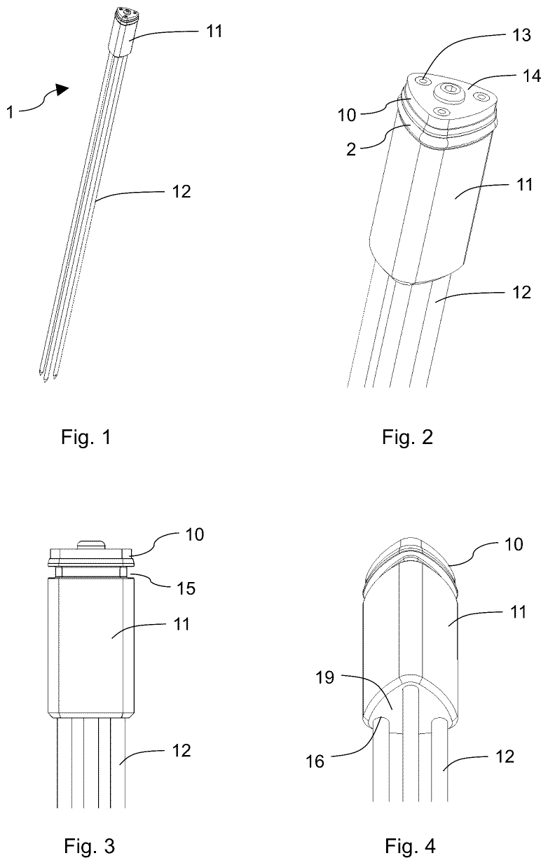

Referring first to FIG. 1, the needle head 1 according to an example of the disclosure, to be used in a modular needle bridge 4 of a meat injection device 5 according to the disclosure, comprises a base 11 that forms a body, which comprises at least one needle 12 extending therefrom. The needle head 1 defines a longitudinal axis, which is shared by the body 11 and the at least one needle 12. Thereby, both the body 11 and the at least one needle 12 also define a longitudinal axis, which is parallel to the previously defined needle head longitudinal axis. In the represented embodiment three needles 12 extend from the base 11. The needle or needles 12 are at least partially embedded in base 11 as is visible in FIG. 4. The needle head base 11 further comprises at least one fluidic inlet 13, in the represented embodiment in FIG. 2, three fluidic inlets 13, which are cavities in the needle head base 11 fluidically connecting the needle 12 to a needle body first surface 14.

The base 11 of the needle head 1 may comprise a needle head plate 10 for providing additional support and engagement surface for the needles 12 to be arranged and fixed in the base 11. The needle head plate 10 is made of a material different from the base 11, and which can provide sufficient structural support for the needle ends, such as a metal. In an exemplary embodiment shown in FIG. 1-4 the needle head plate 10 is a steel plate connected to the body 11 via a screw shown in FIGS. 2 and 3.

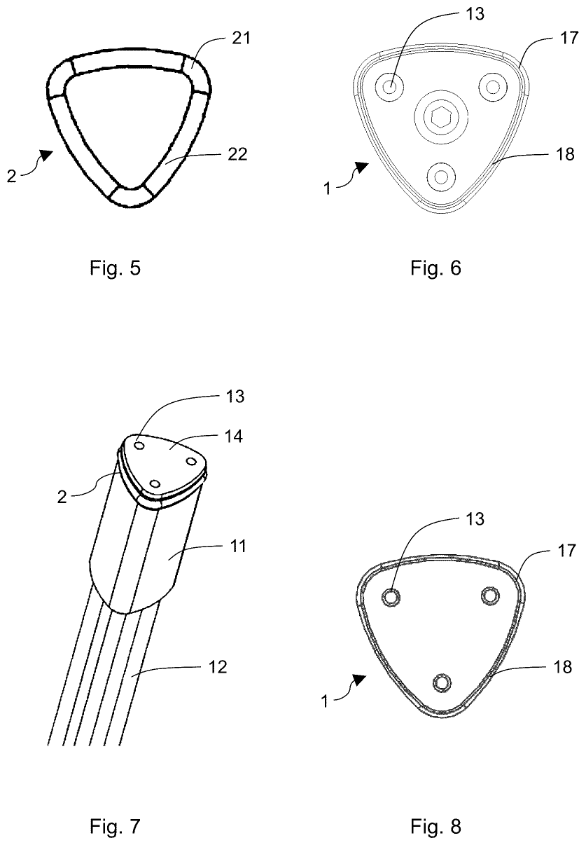

The base 11 of needle head 1 further comprises a groove 15 that extends peripherally around needle head base 11, as shown in FIG. 3. Groove 15 is dimensioned to accommodate sealing means 2 such that the sealing means are fixed on the needle head base 11 securely enough to withstand the drag created by friction between needle head 1 and the interior of needle head cavity 31 when the brine injecting machine is in operation, as illustrated in FIG. 5 where the sealing means 2 is an O-ring.

Alternatively, the periphery of the needle head 1 may comprise at least one annular protrusion arranged around the periphery of the needle head base 11 suited for fixing sealing means (not shown). Such a protrusion may serve the same purpose as groove 15.

In one implementation form (not shown), the depth of groove 15 varies, e.g., becomes shallower, around the second arcs 17 with tighter curvature than first arcs 18. Corresponding sealing means 2 are shaped to sit in groove 15 and be thereby fixed in a releasable manner. The shallower sections of groove 15 around second sections 17 cause the second arcs 21 of sealing means to bulge out sufficiently to compensate for the O-ring material being increasingly stretched around second arcs 17 of the needle base periphery.

In one embodiment, the depth of groove 15 is 11% to 15% shallower around second arcs 17 than around first arcs 18. With a depth between 1.5 mm and 1.7 mm, the depth of groove 15 varies, thus, by approximately 0.2 mm.

FIGS. 6 and 8 show an implementation form of a needle head with a base periphery comprising three first arcs 18 and three second arcs 17 with different curvature and length. As used herein, an (other than the entire curve) of the arc is any portion circumference of a circle.

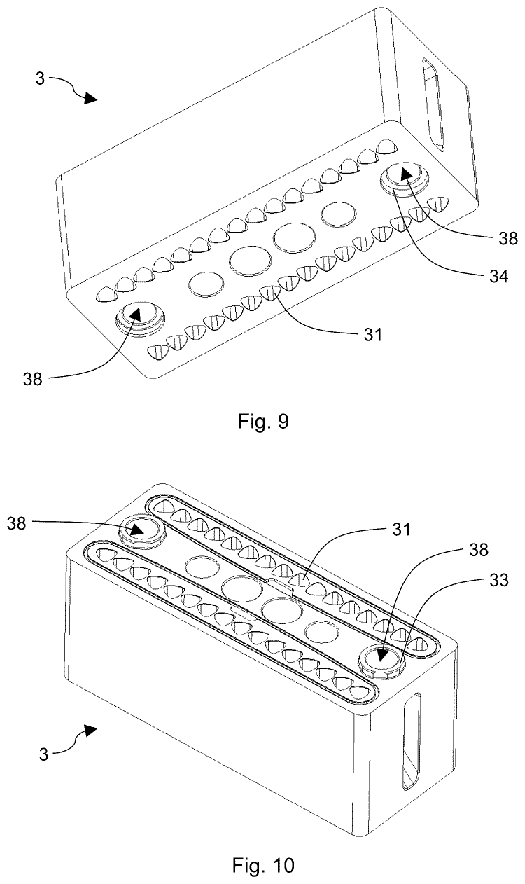

This arrangement results in a needle head base 11 with a periphery defining a shape with three-fold rotational symmetry. Such an arrangement is optimal for comprising three needles 12 while allowing distance d1 between the three needles of the needle head to be substantially equal to a distance (also d1) between two needles 12 pertaining to two separate needle heads 1, when mounted in a needle bridge block 3 as illustrated in FIGS. 9 and 10.

FIGS. 7 and 8 illustrate an embodiment of the needle head 2 where the base 11 is homogeneous, wherein there is either no needle head plate 10 or it is defined as the upper part of the needle head base 11 above the groove 15.

In such embodiments the needle head 1 may be made of a polymer, such as polyoxymethylene (POM), Polyethylene terephthalate (PET), PETP, Ertalyte TX (PETP-TX), Polyethylene (PE), Polyether ether ketone (PEEK), Polytetrafluoroethylene (PTFE), Polyvinylidene fluoride (PVDF) and Polypropylene (PP).

In such embodiments the needle head base 11 is manufactured by injection molding, so as to drilling holes in the needle head base 11 may be avoided, and to reduce production time and capital expenditure. In a possible implementation form, injection molding is followed by machining. As used herein, machining is the process of cutting, shaping, or removing material from a workpiece using a machine tool. One such process is milling. Milling may be used for obtaining an improved finish of the final product.

In a particular implementation form, the needle head base 11 comprises a polymer as disclosed herein and is injection molded onto at least one needle 12.

Alternatively, the needle head 1 may be made of an EN1.4 metal, such as metal selected from a group comprising EN1.4418; EN1.4405; EN1.4401; EN1.4301; EN1.4305; and EN1.4307.

The needles 12 can further be glass blasted such that the grip between needle 12 and needle head 1 is improved.

Alternatively, the needle head 1 may be formed by 3D-printing. In a possible implementation form, 3D-printing is followed by milling. The combination of 3D-printing followed by milling may be particularly advantageous since 3D-printing is cheap and fast, and subsequent milling ensures that the needle bridge cavities and the needle head bases 11 may interact with improved tolerance. Thus, this production method ensures low production costs and high-quality products.

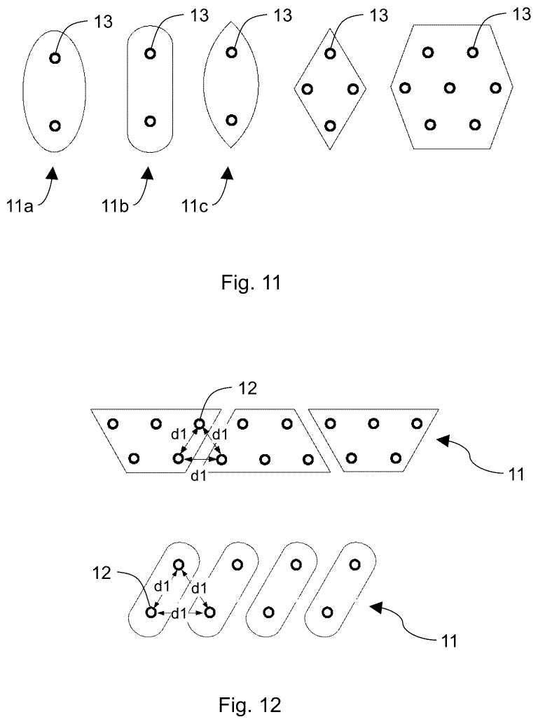

Alternative arrangements of needle heads comprising other numbers of needles, such as 2, 4, or 5 needles according to the invention are illustrated in FIG. 12. Of these, needle head bases with a periphery defining at least two arcs with different centers such as the needle head base 11b are preferred. Those comprising at least two first arcs and two second arcs such as needle head base 11a are even more preferred. It is to be mentioned that any shape illustrated in FIGS. 11-13 are not limiting, but only intended as examples, and that it is to be understood that any sharp-cornered shape, such as shape 11c, may also be arranged as a rounded corner shape, such as shape 11a and is, thus, also included as part of this disclosure.

In exemplary embodiments, a single needle 12 of 4 mm diameter arranged in a needle head 1 may be used for bone-in products, and triple needle 12 arrangements of 2 mm and 3 mm diameters in a needle head 1 may be used for fish and boneless products, respectively.

When arranged contiguously, several needle head base arrangements (FIG. 12, 13) may allow for a first distance (d1) between the plurality of needles 12 of the needle head to be substantially equal to a second distance (also d1) between two needles 12 pertaining to two separate needle heads 11, when mounted in a needle bridge block 3. When needle heads 11 are mounted in needle head cavity 31, the angle formed between three needles 12, wherein at least two needles pertain to two different needle heads 11, is substantially 60°, and, thus, the three needles 12 define an equilateral triangle across needle heads 11 as illustrated in FIG. 14.

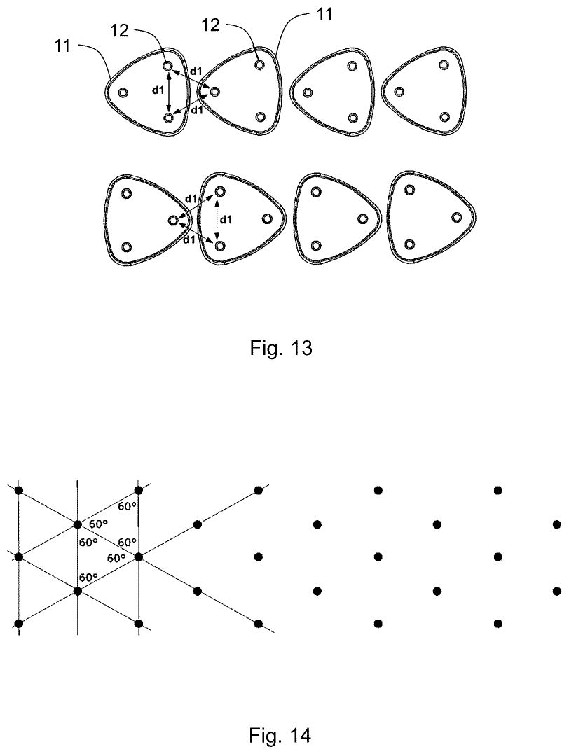

FIG. 13 illustrates how a plurality of needle heads 11 are arranged forming two rows wherein the heads' angle of rotation differs substantially 180° between rows. This arrangement enables obtaining the regular and evenly distributed injection pattern in the meat being processed as illustrated in FIG. 14, depending on the advancement to stroke ratio of a conveyor belt on which the meat is placed.

Turning now to FIGS. 9 and 10, needle bridge block 3 comprises two rows of needle head cavities 31 arranged to form two rows of aligned cavities, wherein the needle head cavities' angle of rotation of the periphery of the cross-section in one row is substantially the same in relation to a longitudinal axis of needle bridge block 3. The cavities' angle of rotation differs substantially 180° between rows. This arrangement enables to obtain the regular and evenly distributed injection pattern in the meat being processed as above and as illustrated in FIG. 14.

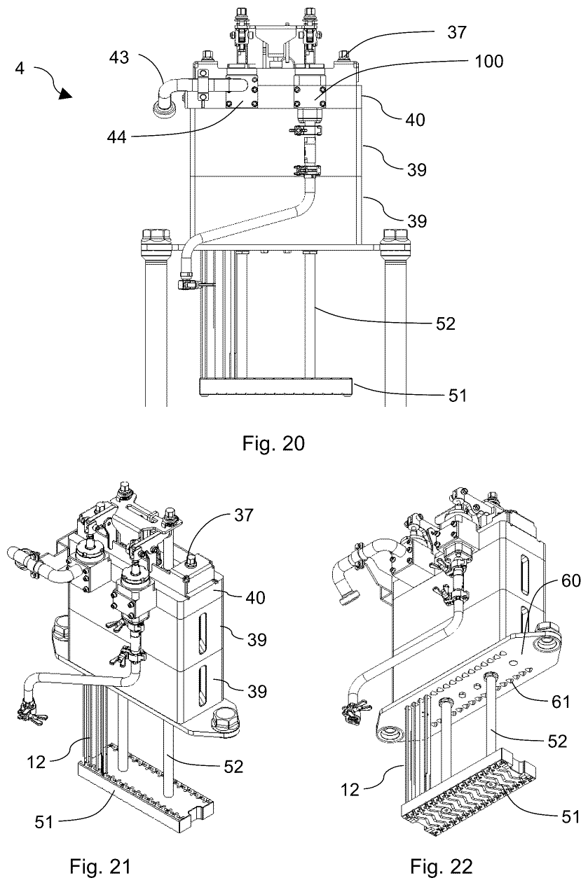

The needle bridge blocks 3 are aligned by alignment means 32, which can comprise protrusions 33 and depressions 34, with a shape that allows depressions 34 to engage with corresponding protrusions 33 when the blocks 3 are stacked, thereby enabling the vertical alignment of the blocks. The needle bridge blocks 3 further comprise two guide channels 38 arranged on opposite sides of the blocks 3 between the rows of needle head cavities 31, to receive elongated fastening means 37, such as a threaded rod to hold stacked blocks 3 in place during operation as shown in FIGS. 18 and 20. In the illustrated examples, the guide channels 38 are integrated with the alignment means 32 for saving space on the surfaces of the blocks, wherein each guide channel 38 comprises a protrusion 33 and a depression 34 arranged on opposite surfaces 35, 35 of the needle bridge blocks 3.

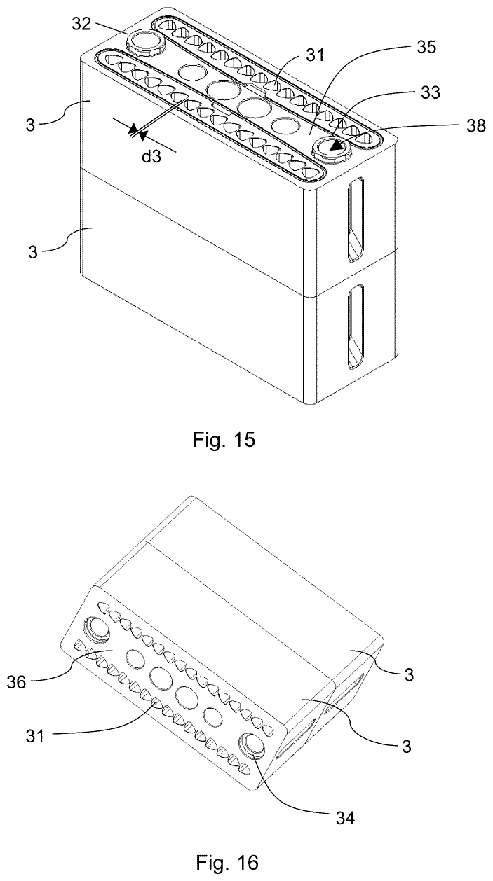

The needle bridge blocks 3, as shown in the illustrated examples in FIGS. 9 and 10, may further comprise cavities on at least two lateral sides to serve as handles for lifting the blocks 3 in place and/or arranging the blocks 3 in a stack as shown in FIG. 15-16.

FIGS. 15 and 16 show two modular needle bridge blocks 3 as described above, arranged vertically adjacent to each other in a stack. As described before, each block 3 comprises needle head cavities 31, arranged in two rows on a first surface 35 of each block 3, and extending through the depth of blocks 3 at least to second surface 36 of the block 3, so to create a continuous elongated cavity within which needle heads 1 may travel. The continuity of the elongated cavity is enabled by alignment means 33. Here, by a pair of corresponding protrusions 33 on the first surface 35 of the first needle block 3 interacting with corresponding cavities 34 on a second surface 36 of the second needle block 3, arranged to receive elongated fastening means 37 through guide channels 38 defined in between.

The needle bridge blocks 3 further comprise additional through-holes running parallel to the guide channels 38, to accommodate for additional columns required for the operation of the needle bridge 4, such as a pair of pawl columns 52 for supporting a stripping plate 51, and a pair of spring columns for supporting column springs 85 arranged thereon for adjusting the tension on the stripping plate 51.

Needle cavities 31 are separated by a distance d3, which is chosen to allow a maximum of needle heads 1 to fit in each block 3, while ensuring sturdiness and structural integrity of cavities 31. Thus, needle head cavities 31 are arranged with respect to each other and the respective edges of the modular needle bridge block 3 such that needle head cavities 31 are spaced evenly at a distance d3.

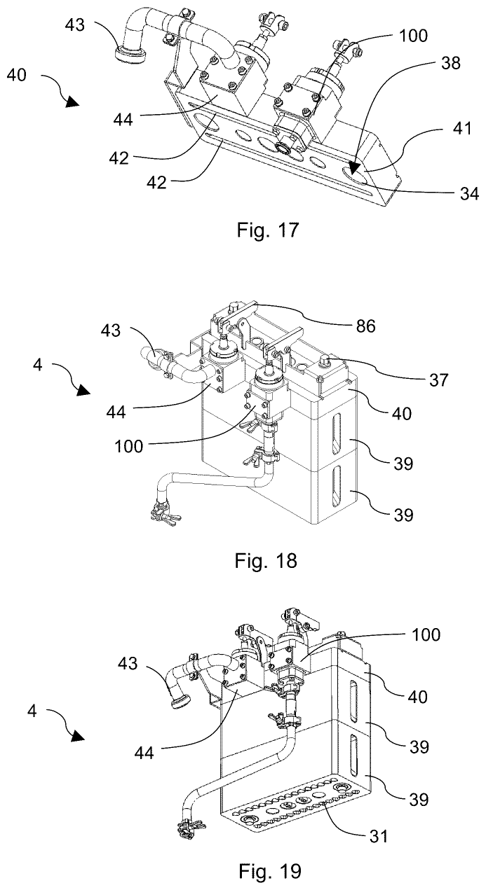

FIG. 17 shows a second needle block 40 comprising liquid supply means with a liquid inlet 43 configured to be connected to a liquid source. Second needle block 40 further comprises a liquid valve 44 arranged between the liquid inlet 43 and at least one liquid channel 42 configured to supply the liquid received from the liquid inlet 43 to needle head cavities 31 arranged in first blocks 39 as described above, as well as a pressure relief valve 100 serving to relieve pressure. The liquid valve 44 and pressure relief valve 100 are operatively connected through rocker arms 86 to pawl columns 52 arranged in the needle bridge 4 when assembled.

The second needle block 40 also comprises alignment means 33, in the form of at least depressions 34 for alignment with first blocks 39 as illustrated in FIGS. 18 and 19 to form a stack of a needle bridge 4. Further details of the liquid valve 44 and pressure relief valve 100 are described in connection with FIGS. 37-38.

FIG. 20 shows the arrangement of FIGS. 17-19 mounted on a support plate 60. Support plate 60 as shown in FIG. 22 comprises cavities 61, which are arranged same number and corresponding location and shape to extend needle head cavities 31 of the needle bridge 4. A stripping plate 51 is arranged to strip meat off the needles 12 during operation and, at an extremity of pawl columns 52. The stripping plate 51 also comprises through-holes that are arranged to receive needles 12 and, thus, match the distribution of the needles 12 in a needle head 1.

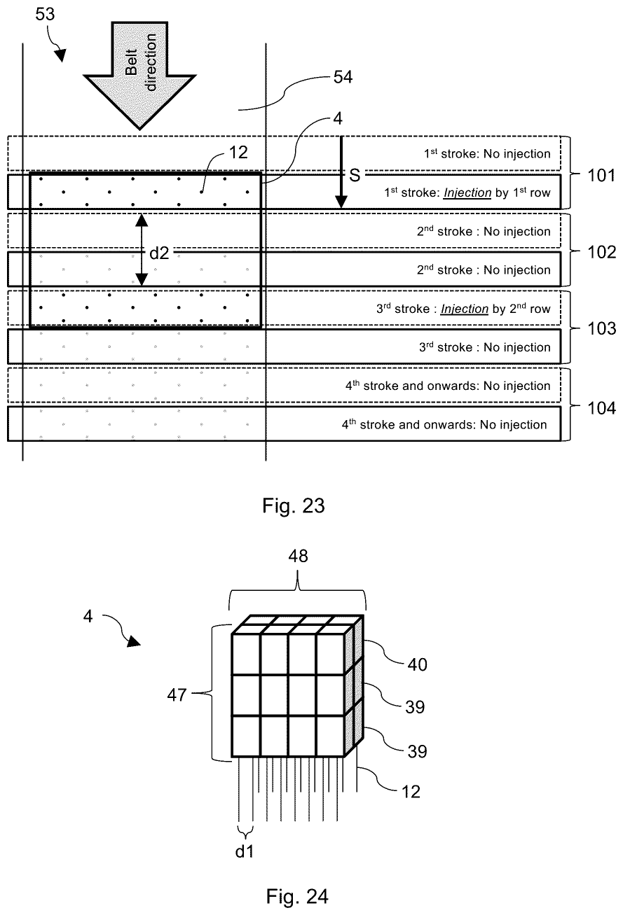

FIG. 23 illustrates an injection sequence comprising conveyor means 53 defining a conveying direction defined by a belt direction. When a meat piece is placed on a conveying surface 54, it is advanced at each stroke by a step distance S, which equals a distance between two parallel rows of needle cavities 31 in a needle bridge 4 according to any possible implementation form as described before. Needle heads 1 comprised within needle cavities 31 of a needle bridge 4 are arranged therein movably in a direction orthogonal to the conveying surface; when the plurality of modular needle bridge blocks 3 are arranged to define successive rows of needle cavities in the conveying direction and the conveyor means 53 are configured to advance in a stepped manner in the conveying direction, each step advancing one step length S; and when a second distance d2 between successive rows of needle cavities in the conveying direction is equal to the step length d2=S, the resulting pattern obtained on the injected meat is a regular and dense pattern of evenly distributed injection sites, as illustrated in FIG. 14.

In this example, the needle heads 1 comprise three needles 12, the needle head cavities 31 being arranged so that the needles 12 are evenly distributed in the rows of repeating equilateral triangular pattern, with a first distance d1 between the needles. Step length S is approximately an integer multiple of the first distance d1.

The equilateral triangular pattern of needles 12 and the relationship between step length S of conveyor means 53 and distance d2 between the successive rows of needle cavities 31 allows for a uniform pattern of liquid injection over varying dimensions of meat products, which in turn ensures that the liquid brine in the meat products travelling below needle bridge 4 is evenly distributed.

In an example the first distance d1 is 11 mm, and step length S=33 mm.

Alternate injection of liquid into the meat product from needle heads 1 arranged in successive rows of needle cavities 31 and skipping injection for one stroke 101, 102, 103, 104 following each injection results in the pattern illustrated in FIG. 14.

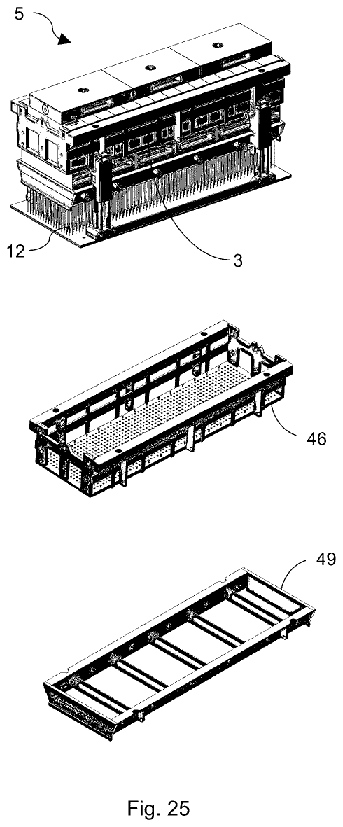

Turning now to FIG. 24, needle bridge 4 comprises a modular stack array 48 comprising a plurality of modular stacks 47 arranged along a first, second and third axes x, Y, z, axes y and z being substantially perpendicular to first axis x, and modular stack array 48 is dimensioned to fulfill the width, length, and height requirement of the needle bridge 4 for use in a brine injecting device 5 as illustrated in FIG. 25.

Alternatively, a needle bridge 4 may comprise a modular stack array 48 comprising a plurality of modular stacks 47 arranged along a first axis x, y or z, and second axis x, y or z, the second axis being substantially perpendicular to the first axis, and modular stack array 48 is thereby dimensioned to fulfill the width, length and/or height requirement of the needle bridge 4 for use in a brine injecting device 5.

It is also possible for needle bridge 4 to comprise a plurality of modular stack arrays 48 arranged along a first, second and/or third axes x, y, z, axes y and/or z being substantially perpendicular to the first axis, the plurality modular stack arrays 48 dimensioned to fulfill the width, length, and/or height requirement of needle bridge 4 for use in a brine injecting device 5.

In stack array 48 of FIG. 24, the plurality of modular needle bridge blocks 3 and second blocks 40 and first blocks 39 are dimensioned substantially equally.

FIG. 25 illustrates an exemplary brine injecting device 5 with an elongated needle bridge 4, where the needle bridge blocks are arranged in a frame 46 with holes corresponding to the needles 12, and a subframe 49 for additional support. Further details of exemplary devices 5 will be described below.

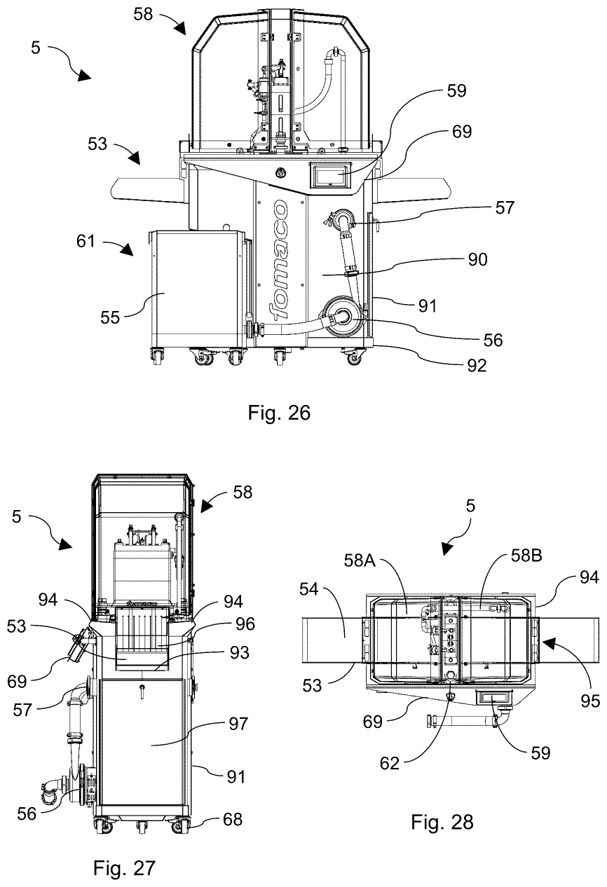

FIGS. 26 through 28 show different views of a meat injection device 5 according to the disclosure.

The device 5 is configured to inject a liquid, in particular brine, into foodstuff such as meat products, with the main purpose of improving conservation, adding flavor, and adding volume. The fabrication of the brine (including the recipe) and operation of the device 5 is the responsibility of the user.

For the quality of the end product, which correlates with the injection level in the foodstuff, it is paramount to be able to control the injection precisely i.e., that the device 5 ensures a uniform distribution and the correct amount of brine in the end product. This is ensured through a combination of brine filtration, injection pressure, injection speed, needle design, and needle bridge design. A third parameter affecting the injection level is brine temperature. This is, however, not controlled through the device 5.

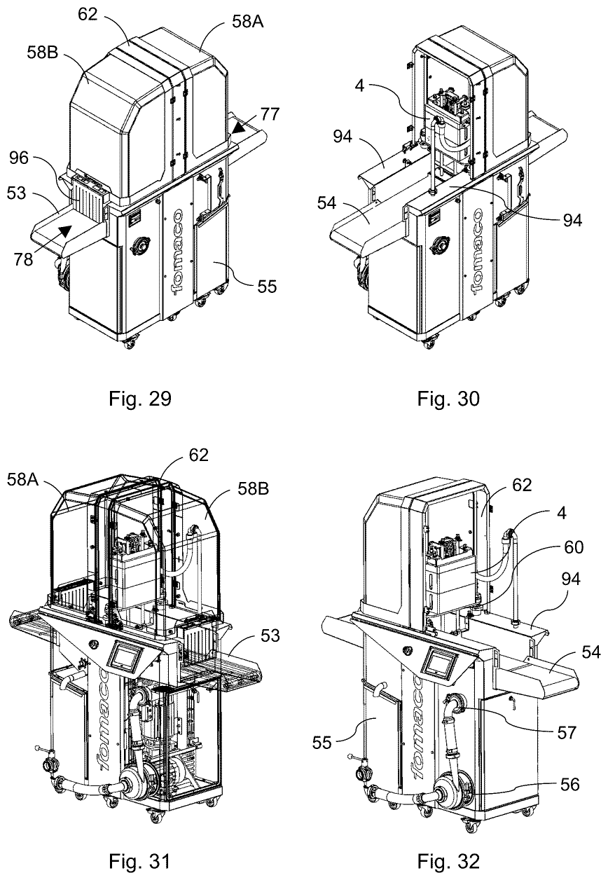

The main components of the meat injection device 5, as illustrated in the figures, are the substantially box-shaped or rectangular cuboid-shaped device housing 61 with side walls 91, a bottom 92 and a top surface 93 enclosing the main operational components of the device 5, with a straight U-shaped channel 95 on top between two support walls 94, and a conveyor 53 arranged in the channel 95. The channel 95 is protected on at least one side by a curtain 96, and a conveying surface 54 serves for placing foodstuff on to be conveyed into the device 5 through the curtains 96 to be injected with brine using a needle bridge 4 arranged above and across the conveying surface 54 with vertically movable hollow injection needles 12. The traveling direction of the conveying surface 54 defines an entrance 77 and exit 78 for the conveyor 53 as shown in FIG. 29, which may be reversed via a control interface 59 as will be explained below.

The housing has a service door 97 arranged on one of the side walls 91, and may have chamfered edges and corners for reducing any risk of accidents and for providing a distinct appearance.

In the housing 61, there is further integrated a removable brine tank 55 arranged to fit neatly to the box-shape and be accessible for removal from a side of the device 5, a pump 56 for pumping brine from the brine tank 55 to be injected into the foodstuff, and a fine filter 57 arranged downstream from the pump 56 for filtering out particles larger than 0.5 mm in diameter to prevent blockage of injection needles 12. For additional filtering upstream from the pump 56 the brine tank may comprise an integrated coarse filter for filtering out particles larger than 2 mm in diameter. The thus fine-filtered brine is forwarded towards a needle bridge 4 arranged below a removable cover 58, the needle bridge 4 comprising needle heads 1 with injection needles 12 through which the foodstuff is injected, as will be explained below. Both the fine filter 57 and the pump 56 is arranged to slightly protrude from the box-shaped housing 61, thereby allowing easier access for cleaning.

The brine tank 55 has three different use cases. In operation the tank 55 is used for brine mixing and as the buffer tank feeding the brine to the system. The coarse filter cage in the top of the tank 55 filters off particles larger than 2 mm. During cleaning the tank 55 is used as a cleaning station to contain all parts that are dismantled from the device 5 for cleaning, such as the removable conveyor belt frame 83, conveyor belt 54, needle bridge 4 parts, injection needles 12 and needle heads 1. When the device 5 is not in operation (parked), the tank 55 is used to store the suction hose.

The device housing 61 further comprises the reversible drive system 70 for the conveyor, and liquid collection means 64 for collecting overflow brine and returning it to the brine tank 55, thereby closing the circle of liquid flow.

The device 5 is operated through a control interface 59 arranged in a wing-shaped control panel 69 at the left side of the device 5 as shown in FIGS. 26 and 27. The control interface 59 may comprise display means that may be a touchscreen module, as well as a rotatable knob for adjusting various settings.

The wing-shaped control panel 69 may be arranged to be removable, e.g. by removing bolts, allowing efficient hardware and software updates without the need for changing or transporting the rest of the device 5. The control panel 69 may also be connected to the side of the device 5 through adjustable connection means, such as hinges, allowing for changing the viewing angle of the control interface 59 on the control panel 69. The shape of the control panel 69 can also be different from the wing-shaped exemplary embodiment shown in FIG. 26, such as rectangular, or any other shape readily conceivable for a skilled person.

To control the injection level the operator can adjust pump pressure and speed (number of strokes of the bridge per minute) on the control panel 69 through the control interface 59. Another feature of the control panel 69 is the option to save pre-defined settings of pump pressure and bridge speed (recipes).

Structures and features that are the same or similar to corresponding structures and features previously described or shown hereinbelow are denoted by the same reference numeral as 30 previously used, not only for simplicity but also to indicate that said features solve the technical problem in an analogous way.

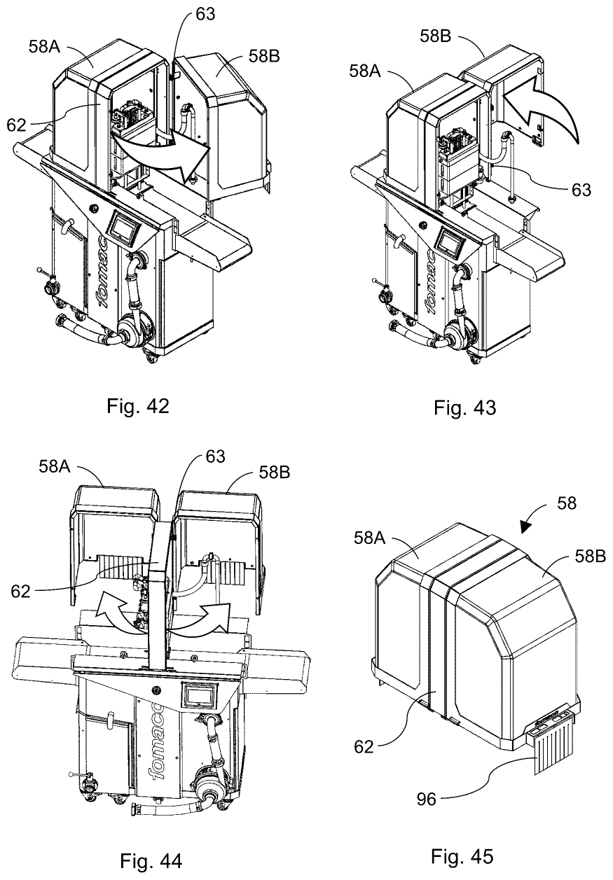

As shown in FIGS. 29 and 30, as well as FIGS. 31 and 32, the removable cover 58 may comprise at least two distinctly operable cover elements, i.e. a first cover element 58A and a second cover element 58B. These may be removable from the housing 61 separately, as shown in FIGS. 30 and 32, allowing access to the conveyor 53 and the needle bridge 4 for cleaning, adjusting, or removal. The cover elements 58A and 58B may also be hinged allowing rotational opening upwards or to the side of one or both elements, as shown in FIGS. 42-44 and will be explained later.

At least one or all of the cover elements 58A and 58B may be transparent for allowing the operator to see through the cover 58 even in a closed state, and monitor the injection process, in particular to be able to see the needle bridge 4 and the conveying surface 54.

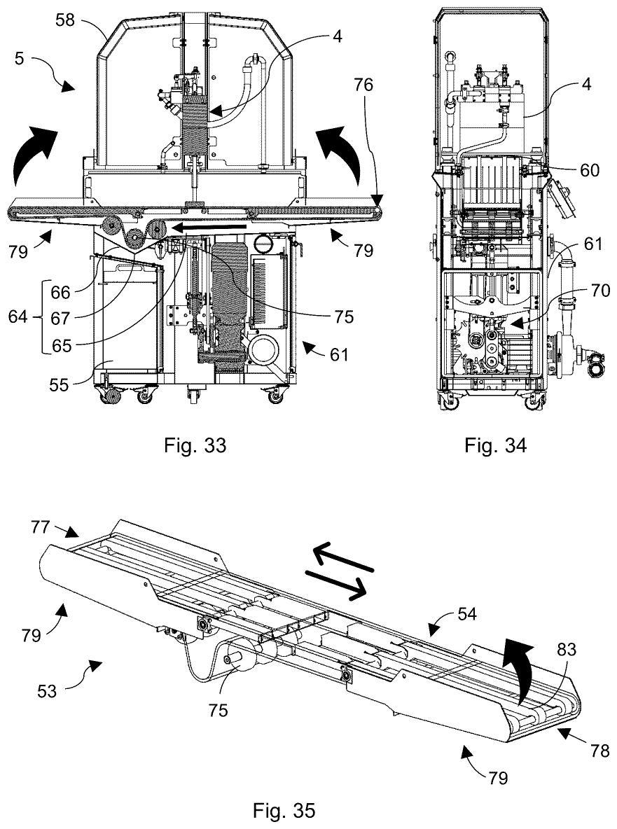

As shown in FIGS. 33 to 35, the conveying surface 54 of the conveyor 53 may be arranged as an endless belt traveling around conveyor pulleys 75, with at least one conveyor pulley 75 being arranged to be driven by the reversible drive system 70 located in the housing 61.

The end sections 79 of the conveyor 53 protruding from the body of the device 5 on both sides and including support elements of the conveyor frame 83 (shown in FIG. 35) can be folded up from their horizontal position to a vertical position into the device housing 61, thereby reducing the footprint of the device when not in use. This allows for an approximately 1200×800 mm total footprint taken up by the box-shaped device 5 when stored away.

The endless belt elements of the conveying surface 54 are held together by conveyor pins and tensioned by the foldable end sections 79 of the conveyor 53 in their horizontal position. At least one conveyor pin 76, as shown in FIG. 33, may be arranged to be removable in an axial direction. Flipping one of the foldable end sections 79 to a non-tensioned vertical position from its tensioned horizontal position releases tension on the conveying surface 54 which makes it easier to remove the conveyor pin 76. The conveying surface 54 can subsequently be dismantled and removed for cleaning or replacement. The mobility of the device 5 is further enhanced by wheels 68, each revolving around a horizontal wheel axis and also arranged to rotate around the vertical rotational axis for better maneuverability.

As further shown in FIG. 33, in the housing 61 there is further arranged liquid collecting means 64 for collecting overflow brine through the conveying surface 54, which is guided by sloping guide surfaces 65 arranged below the conveyor 53 towards a trough 66 protruding down towards the brine tank 55. Openings 67 arranged in the trough 66 lead the overflow brine to the brine tank 55, through the coarse filter as described above. The guide surfaces 65 and the trough 66 also help to visually divide the clean “food processing” area from its surroundings.

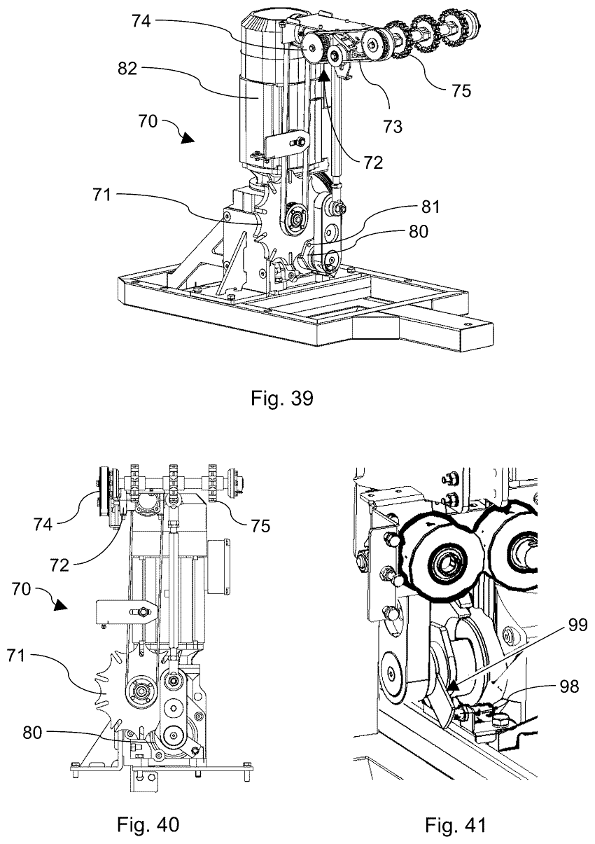

FIG. 34 shows a cross-section at a pane perpendicular that of FIG. 33, illustrating the drive system 70 integrated into the housing 61, which will be explained in detail with respect to FIGS. 39-41. This cross-section further shows the needle bridge 4 arranged on a support plate 60 above the conveying surface 54.

FIG. 35 illustrates the reversible conveyor 53 defining a conveying surface 54, in this case an endless belt, the conveying direction itself defined by the rotational movement of a conveyor pulley 75 driven by the reversible drive system 70, as will be explained below with reference to FIGS. 39-40. When a meat piece is placed on the conveying surface 54 from an entrance 77 (also defined by the conveying direction), it is advanced at each stroke of the conveyor pulley 75 by a step. Needle heads 1 comprised within needle cavities 31 of a needle bridge 4, as shown in e.g. FIGS. 20-22, are arranged movably in a direction orthogonal to the conveying surface 54. When in use, the conveyor 53 is configured to advance in a stepped manner in a conveying direction, each step advancing one step length S, which in a particular embodiment equals a second distance d2 between two parallel rows of needle cavities 31 in a needle bridge 4. When this second distance d2 between successive rows of needle head cavities 31 in the conveying direction is equal to the step length d2=S, the resulting pattern obtained on the injected meat is a regular and dense pattern of evenly distributed injection sites.

As further shown in FIG. 35, the conveyor may comprise a removable conveyor frame 83, which can also be removed from the device 5 once the tension on the conveyor belt 54 is loosened and the belt 54 is removed.

In the illustrated examples through FIG. 26-45 the needle bridge 4 comprises modular needle bridge blocks 3 arranged stacked on top of each other, as described in detail before in connection with FIGS. 15-24. The needle bridge blocks 3 are aligned by alignment means, such as protrusions 33 and depressions 34 arranged in corresponding surfaces of the blocks 3. The modular blocks 3 further comprise fastening means 37, which comprise two guide channels 38 are arranged to receive elongated fastening means 37, such as a threaded rod to hold stacked blocks 3 in place during operation. The modular needle bridge blocks 3 further comprise needle head cavities 31, arranged in two rows, to create a continuous elongated cavity within which needle heads 1 and corresponding needles 12 may travel, for example when any of the needles 12 hit a bone in the meat product on the conveyor 53. The needle head cavities 31 are separated by a distance which is chosen to allow a maximum of needle heads 1 to fit in each block 3, while ensuring sturdiness and structural integrity of cavities 31.

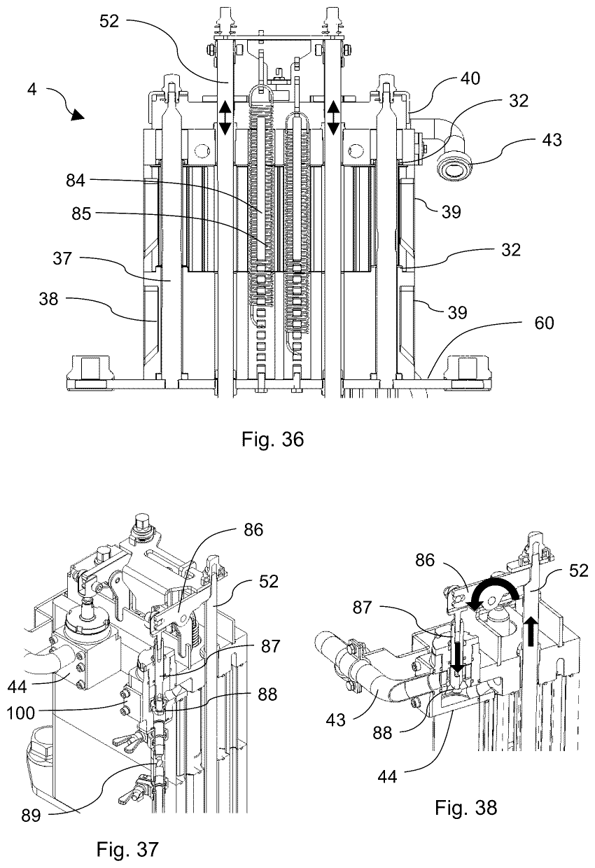

As shown in FIG. 36, the modular needle bridge 4 comprises two types of blocks 3, one or more first needle blocks 39 to define a lower portion of the needle bridge 4 to be placed just above the conveyor 53, with the needle head cavities 31 as described above; and a second needle block 40 arranged on top of the first needle blocks 39, comprising liquid supply means with a liquid inlet 43 that is configured to be connected to the downstream side of the pump 56 after the fine filter 57, for receiving filtered brine from the brine tank 55.

The needle bridge blocks 3 further comprise fastening means, which in the illustrated example are two guide channels 38 arranged on opposite sides of the blocks 3 arranged to receive elongated fastening means 37, such as a threaded rod to hold stacked blocks 3 in place during operation. In the illustrated examples, the guide channels are integrated with the alignment means 32 for saving space on the surfaces of the blocks, wherein each guide channel 38 comprises a protrusion 33 and a depression 34 arranged on opposite surfaces of the needle bridge blocks 3.

The needle bridge blocks 3 further comprise additional through-holes running parallel to the guide channels 38, to accommodate for additional columns required for the operation of the needle bridge 4.

In particular, a pair of pawl columns 52 runs through blocks 3 of the needle bridge 4 for supporting a stripping plate 51 arranged at its lower end. The stripping plate 51 is designed to strip the meat off the needles 12 during the injection operation, as shown in FIGS. 20-22. The stripping plate 51 comprises through-holes that are arranged to receive needles 12 and, thus, match the distribution of the needles 12 as described before.

A pair of spring columns 84 are further arranged through blocks 3 of the needle bridge 4 for providing spring-loading to the operation of the stripping plate 51 via column springs 85 arranged thereon. The spring columns 84 have multiple possible position settings for adjusting the spring tension on the stripping plate 51 and thereby adjusting pressure of the stripping plates on the meat product to be injected. This prevents that the stripping plate 51 squashes softer meat products like fish but also allows to set higher tension for more stiff meat products.

As shown in FIGS. 37-38, the second needle block 40 on top further comprises a liquid valve 44 arranged between the block itself 40 and a liquid inlet 43 to control liquid supply to the needle head cavities 31 and to the needle heads 1 arranged therein, as well as a pressure relief valve 100 arranged downstream from the second needle block 40. The liquid valve 44 and pressure relief valve 100 are operatively connected through rocker arms 86 to the pawl columns 52 arranged in the needle bridge 4.

When the product is advanced to position under the needle bridge 4 the stripping plate 51 supported by the pawl columns 84 will first “hit” the meat product and then retract via the adjustable spring-loaded pawl columns 52 up in the needle bridge 4.

As illustrated in FIG. 38, this retraction will open the liquid valve 44 at the liquid inlet 43 by displacing the liquid valve stem 87 from the liquid valve seat 88 and allow brine flow to the needles 12. With the stripping plate 51 retracted the needles 12 will be pressed into the product and thus the brine will be deposited in the product.

The needles 12 can move freely vertically in the needle cavities 31. The hydraulic pressure from the brine on the needle heads 1 exerts force on the needle heads 1 so that the needles 12 can penetrate the product. If a needle 12 hits a bone in the product the hydraulic force is exceeded, and the needle 12 rejects up into the needle cavity 31 to prevent damage to the needle 12.

On the upstroke of the needles 12, the stripping plate 51 will strip off the product from the needles 12. When the stripping plate 51 is seated in the bottom position the liquid valve 44 will be in a closed position with the liquid valve stem 87 pushed to the liquid valve seat 88.

On the downstream side, as illustrated in FIG. 37, the operation of the stripping plate 51 and corresponding motion of the pawl column 52 will operate the pressure relief valve 100 in a reversed manner, via a rocker arm 86, through the inverse motion of the valve stem 87 of the pressure relief valve 100 with respect to the valve seat 88, i.e. closing the pressure relief valve 100 when the liquid valve 44 is open and vice versa.

The valve seat 88 in the pressure relief valve 100 is spring-loaded, allowing the valve stem 87 to travel further than the valve seat 88.

The valves 44 and 100 have an overlap where both valves are open, allowing air to escape and also equalize the pressure inside the needle bridge 4.

Herein, an additional check valve 89 arranged downstream from the pressure relief valve to prevent air entering the system.

If needle(s) 12 have been rejected on bones on the downstroke the brine pressure on the needle head 1 will cause the needle to return to its seating position in the bridge 4. The needle bridge 4 is then ready for the next downstroke.

In one embodiment the maximum product height that the device 5 can handle is 230 mm and the needle bridge's 4 stroke height is 280 mm. In this case, the conveyor 53 advances one step S in the period from upstroke 230 mm above the conveying surface 54->needle bridge 4 top dead center 280 mm above the conveying surface 54->downstroke 230 mm above the conveying surface 54. This ensures that the conveying surface 54 will only advance when the needles 12 are out of the product. After a step S advancement of the conveying surface 54, the product will be in position for the next downstroke with the needles 12 positioned where the product has not yet been injected. When the product has advanced fully through the device 5 it has been injected with a uniform needle pattern and with the operator-controlled pressure and speed. The product can then leave the device on the conveying surface 54 at the exit side 78.

Optionally, the needle bridge 4 may also be split into two sections along the width of the conveyor surface 54 with separate stripping plates 51, valves 44, and needle cavities 31. The split means that only the section of bridge 4 with a product under the stripping plate 51 will open for flow through the needles 12. This prevents the unnecessary flow of brine that would aerate the brine which is undesired.

In essence, with this system of modular blocks 3 the needle bridge 4 can be fully dismantled from the device 4 for proper cleaning, while also keeping the number of device parts at the bare minimum for reduced complexity during dismantling and assembly.

FIGS. 39-41 illustrate the reversible drive system 70 for the conveyor 53 of the device 5 as described above, which represents a core part of the operation of the device.

Before operating the device 5, brine is prepared in the brine tank 55. If the pump 56 is a centrifugal pump it also needs to be primed before operation. Gravity will ensure brine flows to the pump 56 and no further priming is required.

Once primed, the device 5 can be started up. The control system will first start the pump 56. If it doesn't receive feedback from a pressure sensor that the system is pressurized it will shut down the pump 56 and throw an error to be displayed on the control interface 59. This is to prevent overheating of the gaskets in the pump 56. If the system is pressurized it means that the brine is filtered through the fine filter 57 and pressurized against the liquid valve 44 as described before.

The device 5 will then proceed to start the motor 82 of the drive system 70 for operating the needle bridge 4 and the conveyor 53.

The operator then places the product on the conveyor surface 54, i.e. the conveyor belt on the entrance side 77, and the drive system 70 moves the conveyor surface 54 one step S per stroke of the needle bridge 4, as described above.

The stepped advancement of the conveyor surface 54 is achieved using a Geneva drive as shown in the figures, wherein the motor 82 drives a drive gear 80 with a drive pin 81, that engages a Geneva gear 71, thus converting the continuous rotation of the drive gear 80 into stepped rotation of the Geneva gear 71. An angular gear 72 changes the orientation of the Geneva gear 71, thus enabling practical use of space within the box-shaped housing 61 below the conveyor 53. Timing belts 73 and timing belt pulleys 74 are used to connect the Geneva gear 71, angular gear 72, and the conveyor pulley 75 which drives the conveyor surface 54. The angular gear 72 may be arranged with a 1:1 ratio, but any other configuration and ratio readily conceivable by a skilled person are possible.

Using the Geneva gear 71 and the system of pulleys and belts also enables easy reversibility of the rotation of the gears and pulleys, thus enabling to adapt the device to the circumstances of its use in different production layouts. The direction of the conveyor surface 54 can be set easily on the control interface 59 before starting up the device 5.

FIG. 41 illustrates the use of a proximity switch 98 which is configured to detect a metal flap 99 to ensure home functioning of the needle bridge 4, i.e. that the metal flap 99 is arranged such that the needle bridge 4 is in “home” position when the metal flap 99 is in front of the proximity switch 98.

FIGS. 42 through 44 illustrate the different possibilities for accessing the needle bridge 4 and conveyor 53 of the device 5 through the removable cover 58. As mentioned before, this removable cover 58 may comprise at least two distinctly openable cover elements, e.g. a first cover element 58A and a second cover element 58B. These may be openable separately, as shown in FIG. 42-43, or at the same time, as shown in FIG. 44.

In an embodiment, the cover elements 58A and 58B are connected through hinge elements 63 to a central cover frame 62 allowing rotational opening of one or both elements 58A and 58B. In other words, this hinged solution allows for either opening up one of the cover elements 58A or 58B up to 180 degrees around its hinges 63 with respect to the cover frame 62, as shown in FIG. 43, or for the opening up of both cover elements 58A and 58B up to 90 degrees around its hinges 63 with respect to the cover frame 62.

As shown in FIG. 45, either or both cover elements 58A and 58B may be arranged to be transparent, e.g. by using thermo molded, transparent polycarbonate shells. This enables the operator to see the processing inside the device 5 from all viewing angles. This enables quick reaction if something needs attention, in contrast to prior art devices that have a limited view inside the machine.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. A single needle bridge block or other unit may fulfill the functions of several claims recited in the claims. The mere fact that certain measures are recited in mutually different dependent claims does not indicate that a combination of these measured cannot be used to advantage.

The reference signs used in the claims shall not be construed as limiting the scope. Unless otherwise indicated, the drawings are intended to be read together with the specification, and are to be considered a portion of the entire written description of this disclosure. As used in the description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader.

1. A modular needle bridge block for assembling a needle bridge of a meat injection device, the modular needle bridge block comprising aligning means for aligning a plurality of needle bridge blocks adjacently, the modular needle bridge block comprising at least one needle head cavity for receiving a needle head;
wherein the at least one needle head cavity defines a non-circular cross-section at least along a portion of its length.

2. The modular needle bridge block according to claim 1, comprising a plurality of needle head cavities arranged with respect to each other and the respective edges of the modular needle bridge block such that needle head cavities of one block and needle head cavities of adjacent blocks are spaced evenly at a third distance d3 when a plurality of modular needle bridge blocks are arranged adjacently.

3. A modular kit for assembling a needle bridge of a meat injection device, the modular kit comprising at least one first block according to claim 1, and a second block configured to be arranged adjacent to a first block, the second block comprising aligning means for aligning the second block with the at least one first block in a stacked arrangement, wherein at least one of the second blocks comprises liquid supply means arranged to be in fluid communication with the at least one needle head cavity of a corresponding first block when the second block is arranged on top of the first block.

4. The modular kit according to claim 3, wherein the second block-comprises a second block bottom surface for placing on top of a corresponding first block, and wherein the liquid supply means comprises at least one liquid channel arranged in the second block bottom surface, each liquid channel being arranged to align with at least one needle head cavity of the corresponding first block to define a sealed fluid communication passage between the at least one needle head cavity and the liquid channel.

5. The modular kit according to claim 4, wherein each liquid channel is an elongated recess in the second block bottom surface and is arranged to define a sealed fluid communication passage between a plurality of needle cavities and the liquid channel.

6. A needle bridge for a meat injection device, the needle bridge comprising a plurality of modular needle bridge blocks according to claim 1 arranged adjacently and aligned by the aligning means comprised in the modular needle bridge blocks to define a needle bridge bottom surface, with each of the at least one needle head cavity being accessible from the needle bridge bottom surface.

7. The needle bridge according to claim 6, wherein the aligning means comprises a frame configured for receiving a plurality of modular needle bridge blocks arranged adjacently along at least one axis x, y, or z.

8. The needle bridge according to claim 6, wherein a second block arranged on top of at least one first block defines a modular stack, and wherein the needle bridge comprises a plurality of modular stacks arranged adjacently with respect to each other.

9. A meat injection device comprising conveyor means defining a conveying direction, the conveyor means comprising a conveying surface for placing meat products;
the meat injection device further comprising a needle bridge according to claim 6 comprising a plurality of modular needle bridge blocks arranged adjacently and aligned by aligning means, each modular needle bridge block comprising at least one needle head cavity with a needle head arranged therein movably in a direction orthogonal to the conveying surface;
wherein the plurality of modular needle bridge blocks are arranged to define successive rows of needle head cavities in the conveying direction with a second distance d2 defined between successive rows;
wherein the conveyor means are configured to advance in a stepped manner in the conveying direction, each step advancing one step length S; and
wherein the second distance d2 between successive rows of needle head cavities in the conveying direction is equal to the step length d2=S.

10. A meat injection device according to claim 9, wherein each of the needle heads comprise three needles, the needle head cavities being arranged so that the needles are evenly distributed in the rows of needle cavities in an equilateral triangular pattern with a first distance d1 between the needles; and wherein the step length S is a integer multiple of the first distance d1.

11. A needle head for use in a brine injecting needle bridge, the needle head defining a longitudinal axis and comprising:
a base, wherein the base forms a body and has a substantially non circular cross section, the cross section lying substantially orthogonally to the longitudinal axis, and
at least one needle extending from the base; and
wherein the cross section is substantially non-circular.

12. The needle head according to claim 11, wherein the periphery of the cross section comprises at least two arcs, preferably at least two circular arcs, that do not share the same center.

13. The needle head according to claim 12, wherein the periphery of the cross section comprises a first arc and a second arc, the arcs each defined at least by a curvature and a length, wherein the first and second arcs differ in arc curvature.

14. The needle head according to claim 13, wherein the cross-section periphery comprises at least two first arcs substantially equal in curvature and length, and at least two second arcs substantially equal in curvature and length.

15. The needle head according to claim 14, wherein the cross-section periphery comprises three first arcs substantially equal in curvature and length, and three second arcs substantially equal in curvature and length such that the periphery defines a shape with three-fold rotational symmetry.

16. The needle head according to claim 11, wherein the needle head base comprises a groove arranged peripherally for releasably attaching sealing means.

17. The needle head according claim 11 comprising at least three needles wherein the insertion points of three needles into the needle head base are arranged at substantially 60°.

18. The needle bridge block according to claim 1, wherein the at least one needle head cavity is arranged to receive a needle head for use in a brine injecting needle bridge, the needle head defining a longitudinal axis and comprising:
a base, wherein the base forms a body and has a substantially non-circular cross section, the cross section lying substantially orthogonally to the longitudinal axis, and
at least one needle extending from the base;
wherein the cross section is substantially non-circular.

19. The needle bridge block according to claim 18 comprising a plurality of needle head cavities arranged such that a distance between a plurality of needles of a needle head is substantially equal to a distance between two needles pertaining to two separate needle heads, when mounted in the needle bridge block.

20-24. (canceled)

25. An injection device for injecting a liquid into meat comprising
a housing,
a conveyor comprising a conveying surface arranged for moving foodstuff between an entrance arranged at one side of the housing and an exit arranged at an opposite side of the housing;
a needle bridge arranged above the conveying surface, the needle bridge comprising a plurality of hollow injection needles arranged movably in a direction orthogonal to the conveying surface; and
a drive system configured to move the conveying surface in at least two opposite conveying directions between the entrance and the exit.

26. The injection device according to claim 25, wherein the conveying surface is part of an endless belt arranged to be moved by at least one reversibly rotatable conveyor pulley operatively connected to the drive system.

27. The injection device according to claim 25, wherein the conveying surface is arranged to revolve around at least one conveyor pin, the at least one conveyor pin being arranged removably in the conveyor to provide tension along the opposite conveying directions and to remove the tension when the at least one conveyor pin is removed from the conveyor.

28. The injection device according to claim 27, wherein at least one conveyor pin is arranged to be accessible and removable from at least one side of the conveyor, allowing the conveying surface to be removed from the conveyor.

29. The injection device according to claim 25, wherein the drive system is configured to move the conveying surface in a stepped manner in at least one of the conveying directions, each step advancing the conveying surface with one step length S per stroke of the needle bridge.

30. The injection device according to claim 29, wherein the drive system comprises a Geneva drive comprising a drive gear driven by a reversible operation, continuously rotating drive means, the drive gear comprising a drive pin arranged to periodically engage and disengage a slot arranged in a Geneva gear, while turning the Geneva gear at an angle defined by the radius and the number of slots of the Geneva gear, thus converting the continuous rotation of the drive means into a stepped rotation of the Geneva gear.
